(19) United States
(12) Patent Application Publication
(10) Pub. No.: US 2023/0172098 A1
(43) Pub. Date: Jun. 8, 2023

(54) FERTIGATION SYSTEM AND METHOD

(71) Applicant: Rain Bird Corporation, Azusa, CA (US)

(72) Inventor: Steven D. Geerligs, Tucson, AZ (US)

(21) Appl. No.: 17/545,904

(22) Filed: Dec. 8, 2021

(51) Int. Cl. A01C 23/04; A01C 21/00

(52) U.S. Cl. CPC A01C 23/042; A01C 21/007

(57) ABSTRACT

Apparatus, system, and method are provided herein for causing and controlling the injection of fertilizer into an irrigation of an irrigation system. The fertigation system comprises a fertigation supply unit including at least one storage container containing at least one of a fertilizer component, a herbicide, and an insecticide coupled to a irrigation of the irrigation system. A fertigation control unit is coupled to the fertigation supply unit. The fertigation control unit is configured to cause the fertigation supply unit to inject at least some of the fertilizer component, herbicide, and/or insecticide into the irrigation. The fertigation control unit can cause the fertigation supply unit to inject the fertilizer component, herbicide, and/or insecticide in response to at least air temperature data and/or soil temperature data received from a sensor unit, or in response to user input at the fertigation control unit.

### BACKGROUND OF THE INVENTION

### 1. Field of the Invention

The present invention relates to irrigation systems and, in particular, to methods and systems for controlling fertigation to dispense fertilizer components, herbicides, and/or insecticides via water lines of the irrigation systems.

### 2. Discussion of the Related Art

It is known to dispense fertilizer via existing irrigation systems to enhance grass/crop/plant growth and/or yields. This process is more commonly referred to as fertigation. Generally, fertilizers come in a variety of formulations (e.g., mixtures of one or more of nitrogen, phosphorus, and potassium and their derivatives, or the like) depending on the specific grass/crop/plant to be grown, nutrient requirements, and time of year.

Known fertigation systems are configured to enable the user to select when to fertigate, which fertilizer mixture to use, and how much fertilizer to dispense to optimally facilitate plant growth on the user's greenscape. Fertigation can be a source of frustration for home and business owners in trying to figure out the optimal time (e.g., time of year) to perform the fertigation, and which fertilizer mixture is optimal for use, as well as the optimal amount of fertilizer to dispense.

### SUMMARY OF THE INVENTION

Several embodiments of the invention provide a method, system, and apparatus for fertigation via an irrigation system to enhance plant growth and yields.

In some embodiments, a fertigation system includes a fertigation supply unit coupled to a water line of an irrigation system. The fertigation supply unit includes at least one storage container containing at least one of a fertilizer component, a herbicide, and an insecticide. The system further includes a fertigation control unit operatively coupled to a main irrigation controller of the irrigation system and in communication with the fertigation supply unit. The fertigation control unit is configured to send a signal to the fertigation supply unit and the fertigation supply unit being configured to inject at least some of the at least one of the fertilizer component, herbicide, and insecticide from the at least one storage container into the water line in response to receiving the signal from the fertigation control unit. The system further includes at least one of an air temperature sensor, a soil temperature sensor, and a flow sensor coupled to the water line and the fertigation control unit. The air temperature sensor is configured to send to the fertigation control unit temperature data for ambient air. The flow sensor is configured to send to the fertigation control unit flow rate data for at least one of water, the fertilizer component, the herbicide, and the insecticide in the water line. The soil temperature sensor is configured to send to the fertigation control unit temperature data for soil proximate the water line. The fertigation control unit is configured to determine, based on at least one of time of year data stored in the fertigation control unit, air temperature values stored in the fertigation control unit, soil temperature values stored in the fertigation control unit, air temperature data received by the fertigation control unit from the air temperature sensor, and soil temperature data received by the fertigation control unit from the soil temperature sensor: a time for initiating injection, from the fertigation supply unit, of at least some of the at least one of the fertilizer component, herbicide, and insecticide into the water line; and relative amounts of at least one of the fertilizer component, herbicide, and insecticide to be released upon the injection from at least one storage container into the water line.

In some embodiments, a fertigation control unit is operatively coupled to a main irrigation controller of an irrigation system, and the fertigation control unit includes: a memory storing time of year data, air temperature data, and soil temperature data associated with a geographical location where the irrigation system is located; an output configured to be in communication with a fertigation supply unit coupled to a water line of the irrigation system, the fertigation supply unit including at least one storage container containing at least one of a fertilizer component, a herbicide, and an insecticide; and a processor coupled to the memory and the output. Upon a determination by the processor that the time of year data, air temperature data, and soil temperature data support activation of the fertigation control unit, the processor is configured, to generate at the output a signal to the fertigation supply unit, the signal being configured to cause the fertigation supply unit to inject at least some of the at least one of the fertilizer component, herbicide, and insecticide from the at least one storage container of the fertigation supply unit into the water line.

In some embodiments, a method for controlling a fertigation system includes: outputting a signal from a fertigation control unit operatively coupled to: a main irrigation controller of an irrigation system comprising a water line and a fertigation supply unit coupled to the water line and including at least one storage container containing at least one of a fertilizer component, a herbicide, and an insecticide. The fertigation control unit includes a processor and memory containing instructions executable by the processor. The method further includes: receiving, at the fertigation control unit, at least one of air temperature data and soil temperature data from at least one sensor coupled to at least one of the fertigation control unit and the water line; programming the fertigation control unit with historical values of the at least one of the air and soil associated with the geographical location of the irrigation system; analyzing, via the processor of the fertigation control unit and in view of the stored historical values, the at least one of the air temperature data and soil temperature data received from the at least one sensor; and determining by the processor of the fertigation control unit and based on the analyzing: a time for initiating injection, from the fertigation supply unit, of at least some of the at least one of the fertilizer component, herbicide, and insecticide into the water line; and relative amounts of the at least one of the fertilizer component, herbicide, and insecticide to be released upon the injection from the at least one storage container into the water line. The method further includes receiving the signal from the fertigation control unit at the fertigation supply unit; and injecting, responsive to the signal received at the fertigation supply unit from the fertigation control unit, at least some of the at least one of the fertilizer component, herbicide, and insecticide from the at least one storage container of the fertigation supply unit into the water line.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a diagram of a fertigation system including a fertigation control unit according to one embodiment;

FIG. 2 is a functional diagram of a fertigation control unit according to one embodiment;

FIG. 3 is a functional diagram of a fertigation control unit according to another embodiment;

FIG. 4 is a functional diagram of the fertigation control unit of FIG. 3 being connected to an exemplary main irrigation controller according to some embodiments;

FIG. 5 is a functional diagram of a fertigation control unit according to another embodiment, where the fertigation control unit is incorporated into the physical structure of an exemplary main irrigation controller;

FIG. 6 is a functional diagram of a fertigation control unit according to another embodiment, where the fertigation control unit is removably mounted as a module onto an exemplary modular main irrigation controller;

FIG. 7 is a functional diagram of a fertigation supply unit including storage containers and a pump according to one embodiment;

FIG. 8 depicts a flow diagram of an exemplary fertigation control process according to one embodiment for use with various fertigation control systems;

FIG. 9 depicts a flow diagram of an exemplary method for controlling fertigation according to some embodiments for use with various fertigation control systems;

FIG. 10 is a diagram of a fertigation system including a server and smart phone as a fertigation control unit and a plug-in interface device according to one embodiment; and

FIG. 11 is a diagram of a fertigation system including a server and smart phone as a fertigation control unit and a plug-in wireless adapter according to one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to any claims supported by this specification.

Reference throughout this specification to “one embodiment,” “an embodiment,” “some embodiments” or similar language means that a particular feature, structure, or characteristic described in connection with the embodiment/s is included in at least one embodiment of the present invention. Thus, appearances of the phrases “in one embodiment,” “in an embodiment,” “some embodiments” and similar language throughout this specification may, but do not necessarily, all refer to the same embodiment(s).

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

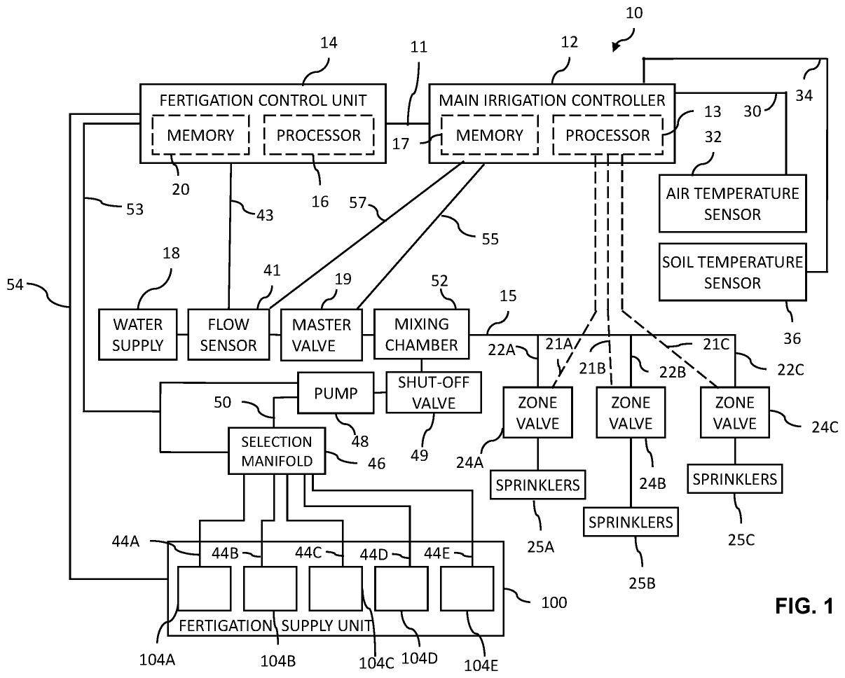

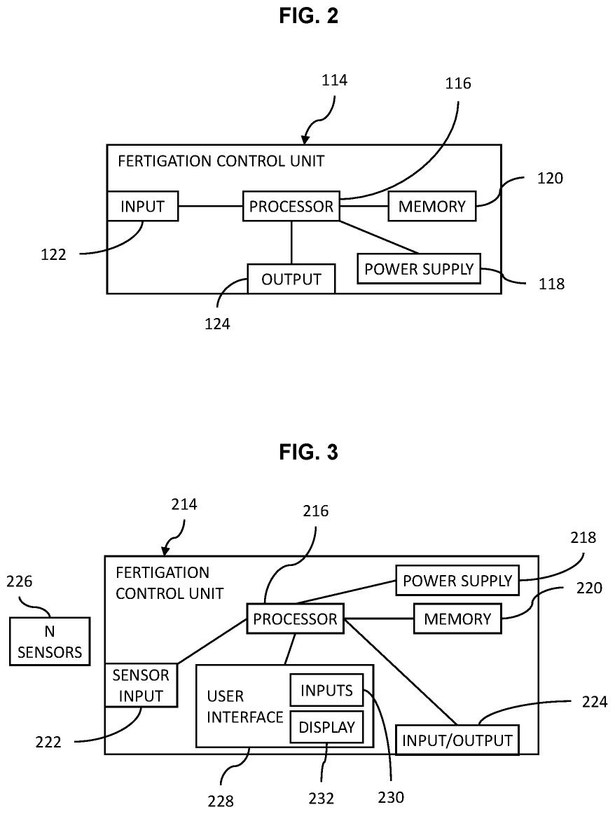

Referring to FIG. 1, one embodiment of a fertigation system 10 is shown. The system 10 includes a main irrigation controller 12 coupled to a fertigation control unit 14 via a communication line 11. In FIG. 1, the fertigation control unit 14 is shown as having only a processor 16 (for example, a microprocessor or a microcontroller) and a memory 20, and the main irrigation controller 12 is shown as having only a processor 13 and a memory 17 for illustration purposes only. FIGS. 2-6 provide a more detailed depiction of the interior components of several exemplary fertigation control units and main irrigation controllers. The main irrigation controller 12 is programmed to execute one or more watering schedules.

In the exemplary embodiment illustrated in FIG. 1, water to the system 10 is supplied from a main water supply 18 and flows via a master valve 19 (which may permit or restrict flow of water, fertilizer component, herbicide, and/or insecticide) through a main water line, referred to herein as an irrigation line 15, a plurality of lateral water lines 22a, 22b, and 22c, and a plurality of zone valves 24a, 24b, and 24c (under control by the irrigation controller 12) to a plurality of sprinklers 25a, 25b, and 25c. In the illustrated embodiment, the main irrigation controller 12 is configured for sending signals to the master valve 19 via a connection 55 (which may be wired or wireless). It will be appreciated that while three water lines 22a, 22b, and 22c have been shown as branches of the irrigation line 15, the system 10 can include any number of lateral water lines branching from the irrigation line 15.

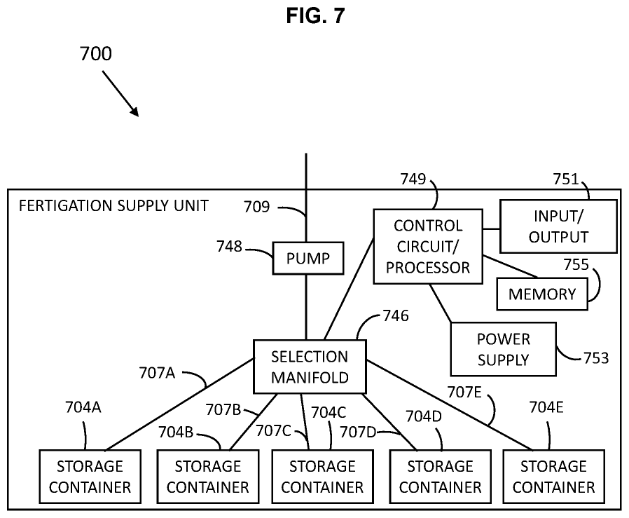

As discussed in more detail below in reference to the embodiment of FIG. 7, one or more components of a general class of fertilizers are supplied to the irrigation line 15 from a fertigation supply unit 700, described in more detail below, which is configured to receive signals from the fertigation control unit 14 and initiate the injection of one or more fertilizer components, herbicides, and/or insecticides from one or more storage containers 104a-104e of the fertigation supply unit 100 (e.g., via the fluid delivery line 709) into the irrigation line 15. Generally, the fertilizers in the storage containers 104a-104e may be embodied as liquid concentrates or solutions including a ratio of one or more fertilizer components, herbicides, and insecticides and a base solvent such as water. It is understood that the ratio of the fertilizer components, herbicides, and insecticides to such base solvent embodied as a solution may be variable and dependent on the application.

The main irrigation controller 12, which controls water flow in the main line 15 and the lateral lines 22a, 22b, and 22c of the fertigation system 10 during the normal irrigation operation of the system 10, is configured to output activation signals (e.g., 24 volt A/C power signals) to respective ones of a plurality of lateral activation lines depicted by the dashed lines 21a, 21b, and 21c, each coupled to a respective zone valve 24a, 24b, and 24c located in a region to be irrigated. The presence of an activation signal on a given activation line 21a, 21b, 21c causes the opening of the respective zone valve 24a, 24b, 24c, and the absence of such activation signal results in the closing of the zone valve. As is well known, each zone valve 24a, 24b, and 24c controls water flow to one or more sprinkler devices 25a, 25b, and 25c, drip lines and/or other irrigation devices that may be coupled to each valve 24a, 24b, and 24c. Typically, the watering devices (e.g., sprinklers 25a, 25b, and 25c) coupled to a given zone valve 24a, 24b, and 24c define a watering zone.

While the main irrigation controller 12 is shown in FIG. 1 as being coupled to the irrigation line 15 via the fertigation control unit 14, it is to be appreciated that the main irrigation controller 12 may be directly coupled to the irrigation line 15. It is also appreciated that the opening and closing of the zone valves 24a, 24b, and 24c may be controlled via control units coupled to each zone valve that demodulate data from modulated power signals sent over a shared Z-wire path (e.g., 2 or 3 wire control path) to all valves 24a, 24b, and 24c.

As discussed in more detail below, the fertigation control units 14 can be coupled to the main irrigation controller 12 directly via a wired or wireless connection or an interface. In some aspects, the fertigation control unit 14 may be embodied in the form of a mobile electronic device (e.g., cell phone, tablet, laptop, etc.) of a user. In some aspects, the fertigation control unit 14 may be embodied in the form of a remote server in communication with the main irrigation controller 12 over a network. Alternatively, the fertigation control unit 14 can be implemented as a part of the main irrigation controller 12, or may be implemented as a module that is configured to be inserted into a complementary slot on a modular main irrigation controller.

In an embodiment depicted in FIG. 2, the fertigation control unit 114 can include a processor 116 electrically coupled to a power supply 118 and a memory 120. The processor 116 can also be electrically coupled to an input 122 that can receive signals from the main irrigation controller 12 or from any other source, for example, a central station or central controller (not shown) through which the fertigation control unit 114 can be remotely controlled. The processor 116 can also be electrically coupled to an output 124, which can be in communication with any number of devices, for example, one or more valves, water lines, and fertilizer component, herbicide, and/or insecticide containers, as discussed below.

In another embodiment, the fertigation control unit 214 can include a processor 216 electrically coupled to a power supply 218 and a memory 220, as shown in FIG. 3. The processor 116 can also be electrically coupled to a sensor input 222 that can receive signals from a plurality of sensors 226, i.e., air temperature sensors, flow sensors, soil temperature sensors, or the like. The fertigation control unit 214 can also receive signals at input/output 224 from the main irrigation controller 12 or from any other source, for example, a central station or central controller (not shown) that can remotely control the fertigation control unit 214. The fertigation control unit 214 can also send signals (e.g., commands) from its input/output 224 to various devices in communication with the fertigation control unit 14, for example, the main irrigation controller 12, and the fertigation supply unit 100.

In the embodiment illustrated in FIG. 3, the fertigation control unit 214 includes a control panel 228 providing a user interface through which a user can manually control the fertigation control unit 214 while being present at the physical location of the fertigation control unit 214. The control panel 228 can include various buttons or touch screen inputs 230 that permit the user to manually input various commands for the fertigation control unit 214 to execute. The control panel 228 can also include an electronic display 232 that permits the user to see various menus and options displayed by the fertigation control unit 214. In some aspects, the fertigation control unit 214 includes a visible status indicator indicating whether at least some of the fertilizer components, herbicide, and/or insecticide from one or more storage containers 104a-104e has been injected into the irrigation line 15.

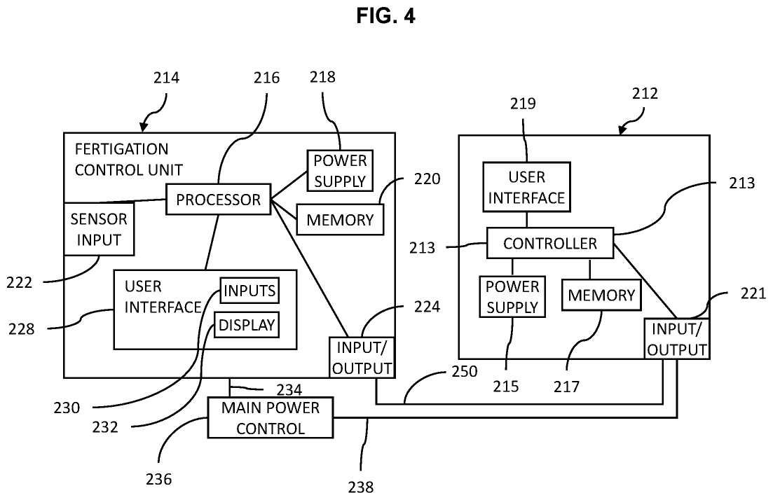

FIG. 4 illustrates an exemplary embodiment where the fertigation control unit 214 is physically separate from and electrically coupled (via connection 250) to an exemplary main irrigation controller 212. The main irrigation controller 212 includes a controller 213 (for example, a microcontroller or a control system) that typically includes one or more processors (such as one or more microprocessors). The controller 213 can be electrically coupled to a power supply 215, a memory 217, a user interface 219, and an output 221. The connection 250 can be in the form of a power line, cable, or a wireless communication channel.

In the embodiment illustrated in FIG. 4, the input/output 224 of the fertigation control unit 214 is in communication via a connection 234 with an optional main power control switch 236, which in turn is in communication via a connection 238 with the input/output 221 of the main irrigation controller 212. At appropriate times, as discussed in more detail below, in response to receiving a signal from the fertigation control unit 214, the main power control switch 236 is configured to provide electrical power to the main irrigation controller 212. It is to be appreciated that such a signal can be generated by the processor 216 of the fertigation control unit 214 either in response to an input such as a command entered manually by a user via the user interface 228, or a command input initiated at a central station or a central controller remote to the fertigation control unit 214.

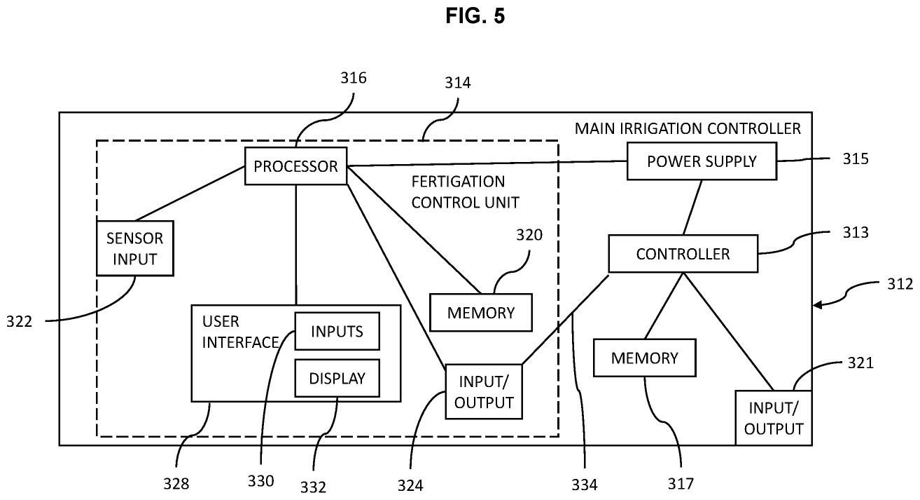

In another embodiment illustrated in FIG. 5, the fertigation control unit 314 is implemented into, and forms a part of, the physical structure of the main irrigation controller 312. As shown in FIG. 5, the fertigation control unit 314 is identical to the fertigation control unit 214 of FIG. 4, except that it does not have its own power supply (like the power supply 218). Instead, the processor 316 of the fertigation control unit 314 is electrically coupled to a power supply 315 of the main irrigation controller 312. It is to be appreciated, however, that the fertigation control unit 314 can also include its own power supply such that the processor 316 could be coupled to the power supply 315 of the main irrigation controller 312, the power supply (not shown) of the fertigation control unit 314, or both. In the embodiment illustrated in FIG. 5, the main irrigation controller 312 includes a controller 313 (for example, a microcontroller or a control system) having one or more processors (for example, one or more microprocessors), a power supply 315, a memory 317, and an input/output 221 for communicating with external devices.

While the fertigation control unit 314 and the main irrigation controller 312 have been illustrated in FIG. 5 as each having their own processor and memory, it is to be appreciated that the fertigation control unit 314 may be configured without the memory 320 such that it utilizes the memory 317 of the main irrigation controller 312. Similarly, it is to be appreciated that the fertigation control unit 314 may be configured without the processor 316 such that it utilizes the controller 313 of the main irrigation controller 312, which may be programmed to execute all of the fertigation functions of the processor 316. As shown in FIG. 5, the processor 316 is electrically coupled to a sensor input 322 that can receive signals from a plurality of sensors, i.e., air temperature sensors, soil temperature sensors, and/or flow sensors. While the sensor input location 322 has been depicted in FIG. 5 as being a part of the fertigation control unit 314, the fertigation control unit 314 can be configured without the sensor input location 322 such that it utilizes a sensor input location (not shown) implemented into the structure of the main irrigation controller 312.

In the embodiment illustrated in FIG. 5, the input/output 324 of the fertigation control unit 314 is in communication via an electrical connection 334 with the controller 313 of the main irrigation controller 312. At appropriate times, as discussed in more detail below, the processor 316 of the fertigation control unit 314 is configured to send one or more signals via the connection 334 to the controller 313 of the main irrigation controller 312. It is to be appreciated that such signals can be generated by the processor 316 in response to an input such as a command entered manually by a user via the user interface 328 and/or a command initiated at a central station remote to the fertigation control unit 314.

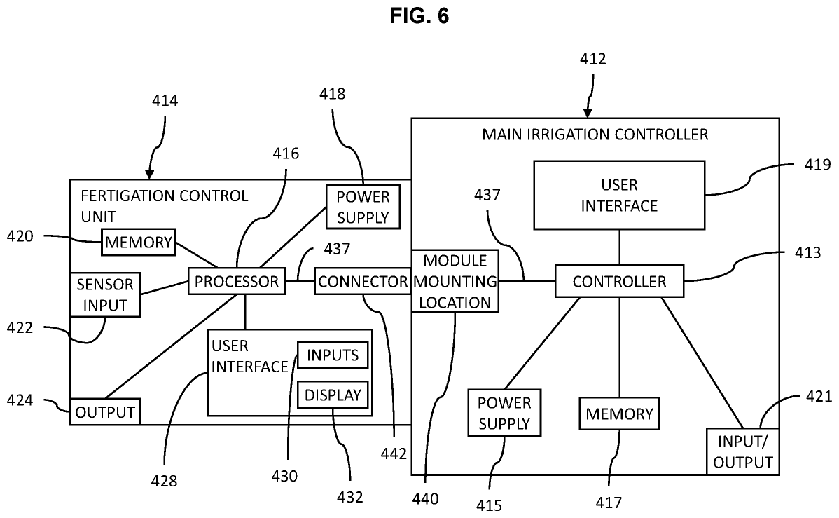

FIG. 6 illustrates another exemplary embodiment where a fertigation control unit 414 is a module that can be removably mounted onto the main irrigation controller 412. In this form, the main irrigation controller 412 is a modular irrigation controller and includes a controller 413 (for example, a microcontroller or a control system) including one or more processors (for example, one or more microprocessor), a power supply 415, a memory 417, a user interface 419, and an input/output 421. The main irrigation controller 412 further includes at least one module mounting location 440 configured to accommodate the docking and electrical coupling of the fertigation control unit 414 and/or other traditional expansion station modules. To that end, the fertigation control unit 414 includes a connector 442 configured to mate with the module mounting location 440 to mount the fertigation control unit 414 to the main irrigation controller 412.

The connector 442 can include pins that carry power and data signals from the fertigation control unit 414 to the main irrigation controller 412. While one module mounting location 440 has been shown in FIG. 6, it is to be appreciated that the main irrigation controller 412 may include a plurality of module mounting locations 440. The module mounting location 440 may be accessible from the exterior of the main irrigation controller 412 housing, or may be located in the interior of the main irrigation controller 412 housing such that the mounting of the fertigation control unit 414 to the main irrigation controller 412 would require removal of one or more panels on, or partial disassembly of, the main irrigation controller 412.

The connector 442 permits the processor 416 of the fertigation control unit 414 to send signals to and/or receive signals from the controller 413 (for example, a microcontroller or control system) of the main irrigation controller 412. For example, the controller 414 of the main irrigation controller 412 can send a signal via an electrical connection 437 through the connector 442 and the module mounting location 440 to the processor 416 of the fertigation control unit 414 to provide electrical power to the fertigation control unit 414. It is to be appreciated that such a signal can be generated by the processor 416 in response to an input such as a command entered manually by a user via the user interface 428 and/or an input such as a command initiated at a central station or a central controller remote to the fertigation control unit module 414.

While the fertigation control unit 414 and the main irrigation controller 412 have been illustrated in FIG. 6 as each having their own processor and memory, it is to be appreciated that the fertigation control unit 414 may be configured without the memory 420 such that it utilizes the memory 417 of the main irrigation controller 412. Similarly, it is to be appreciated that the fertigation control unit 314 may be configured without the processor 416 such that it utilizes the controller 413 of the main irrigation controller 412, which may be programmed to execute all of the fertigation functions of the processor 416.

In the embodiment of FIG. 6, the processor 416 of the fertigation control unit 414 is electrically coupled to an output 424. The fertigation control unit 414 can output signals to, for example, the fertigation supply unit 100, via the input/output 421 of the main irrigation controller, or via the output 424. As shown in FIG. 6, the processor 416 is also electrically coupled to a sensor input 422 that can receive signals from a plurality of sensors, i.e., air temperature sensors, flow sensors, and/or soil temperature sensors, or the like. While the sensor input location 422 has been depicted in FIG. 6 as being a part of the fertigation control unit 414, the fertigation control unit 414 can be configured without the sensor input location 422 such that it utilizes a sensor input location (not shown) implemented into the structure of the main irrigation controller 412. When so configured, the controller 413 of the main irrigation controller 412 can send a signal (including, e.g., air and/or soil temperature reading data) via the electrical connection 437 through the connector 442 and the module mounting location 440 to the processor 416 of the fertigation control unit 414.

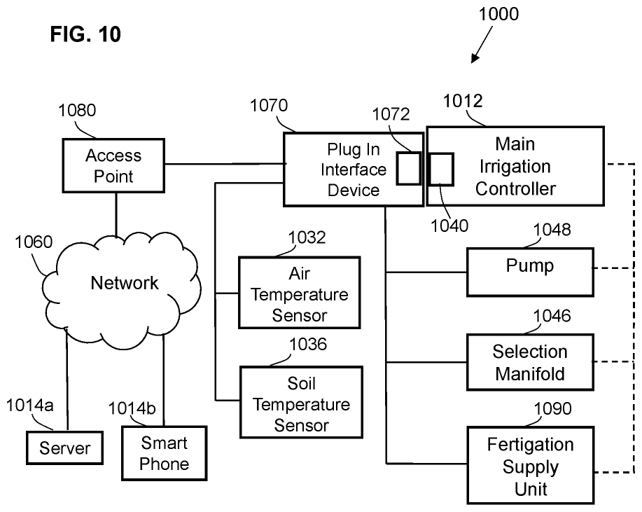

FIG. 10 illustrates another exemplary embodiment of a fertigation system 1000 where the fertigation control unit 14 is in the form of a remote server 1014a and/or a smart phone 1014b (which may be a mobile phone, a tablet, or the like) that can be communicatively coupled over a network 1060 and via a plug-in interface device 1070 to the main irrigation controller 1012. In other words, in this embodiment, instead of a stand-alone fertigation control unit 14 as in FIG. 1, the fertigation system 1000 is configured to enable a server 1014a and/or a smart phone 1014b to perform the functions of the fertigation control unit 14 and control the fertigation functions of the system 1000. In this embodiment, the main irrigation controller 1012 includes at least one module mounting location 1040 configured to accommodate the docking and electrical coupling of a plug-in interface device 1070.

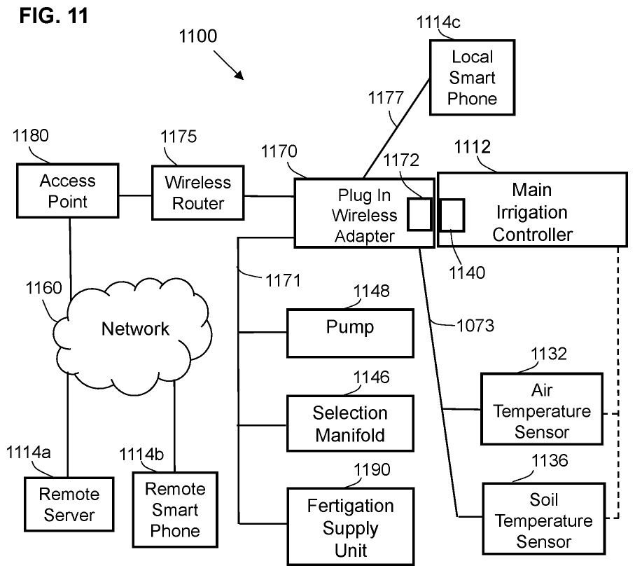

In FIG. 10, the connections between the plug-in interface device 1070 and the server 1014a and smart phone 1014b are contemplated to be wired connections, but it will be appreciated that wireless connections may be used instead, as will be described in more detail in FIG. 11. In some aspects, the remote server 1014a is permitted to interact with the main irrigation controller 1012 via the plug-in interface device 1070, giving the remote server 1014a the functionality of a fertigation control unit akin to the fertigation control unit 14 in FIG. 1 In some aspects, the smart phone 1014b can include an application which allows the user of the smart phone 1014b to interact with the main irrigation controller 1012 via the plug-in interface device 1070, giving the smart phone 1014b the functionality of a fertigation control unit akin to the fertigation control unit 14 in FIG. 1. Although not depicted in FIG. 10, the plug-in interface device 1070 can communicate (via a wired or wireless connection) with other components of the fertigation system 1000 (e.g., air temperature sensor 1032, soil temperature sensor 1036, pump 1048, selection manifold 1046, fertigation supply unit 1090, flow sensor, etc.).

In some embodiments, the plug-in interface device 1070 can be completely configured while communicating directly with the remote server 1014a and/or smart phone 1014b. For example, the user of the remote server 1014a and/or smart phone 1014b can configure all parameters and all settings of the plug-in interface device 1070 (i.e., not only an initial setup of the plug-in interface device 1070, but also perform all other fertigation functions described herein, such as configuring fertigation programs) while communicating between the remote server 1014a and/or smart phone 1014b and the plug-in interface device 1070. During configuration, the server 1014a and/or smart phone 1014b can provide the plug-in interface device 1070 with user information which can include a user-defined password. The plug-in interface device 1070 may later require communications transmitted to the plug-in interface device 1070 to include the password. The remote server 1014a and/or smart phone 1014b can also provide network information (for later communication via a network, such as a local area network) to the plug-in interface device 1070.

In FIG. 10, the server 1014a and smart phone 1014b communicate with the plug-in interface device 1070 via the access point 1080. In some embodiments, if communicating according to a Wi-Fi standard, the server 1014a and/or smart phone 1014b can provide the plug-in interface device 1070 with a service set identifier (SSID) and key associated with the access point 1080. Once connected to the access point 1080, the plug-in interface device 1070 is addressable by the server 1014a and/or smart phone 1014b from remote locations. In some embodiments, the plug-in interface device 1070 can transmit information (e.g., notifications, alerts, other data, etc.) to the server 1014a and/or smart phone 1014b via the network 1060. The access point 1080 can transmit messages to the plug-in interface device 1070 based on the communications between the server 1014a and smart phone 1014b and the access point 1080. The access point 1080 can transmit messages from the plug-in interface device 1070 based on the communications between the air temperature sensor 1032, soil temperature sensor 1036, pump 1048, selection manifold 1046, fertigation supply unit 1090, and main irrigation controller 1012 and the access point 1080.

In the embodiment shown in FIG. 10, the access point accesses a wide area network (“WAN”) (e.g., the Internet) via the communications network 1060 (optionally, via a modem). In one embodiment, the access point 1080 creates a local network (i.e., a wired and/or wireless local area network (“LAN”)). In such embodiments, the server 1014a and smart phone 1014b and the plug-in interface device 1070 can communicate with the access point 1080 via the local network. This method of communication is useful where an internet connection is not required for the server 1014a or smart phone 1014b to communicate with the plug in interface device 1070, for example, if an internet connection (i.e., over network 1060) has failed or is not available.

With reference to FIG. 10, the plug-in interface device 1070 includes a connector 1072 configured to mate with the module mounting location 1040 to mount the plug-in interface device 1070 to the main irrigation controller 1012. The connector 1072 can include pins that carry power and data signals from the server 1014a and/or smart phone 1014b to the main irrigation controller 1012 and vice versa. While one module mounting location 1040 has been shown in FIG. 10, it is to be appreciated that the main irrigation controller 1012 may include a plurality of module mounting locations 1040. The module mounting location 1040 may be accessible from the exterior of the main irrigation controller 1012 housing, or may be located in the interior of the main irrigation controller 1012 housing such that the mounting of the plug-in interface device 1070 to the main irrigation controller 1012 would require removal of one or more panels on, or partial disassembly of, the main irrigation controller 1012.

The connector 1072 permits the server 1014a and/or smart phone 1014b to send signals to and/or receive signals from the main irrigation controller 1012. For example, the server 1014a and/or smart phone 1014b can send a signal over the network 1060 via a wired or wireless connection through the connector 1072 and the module mounting location 1040 to the main irrigation controller 1012. It is to be appreciated that such a signal can be generated in response to an input such as a command entered manually by a user via the user interface (e.g., a mobile app) installed on the smart phone 1014b and/or an input such as a command initiated at the server 1014a remote to the main irrigation controller 1012.

As shown in FIG. 10, the plug in interface device 1070 permits air temperature sensor 1032 and soil temperature sensor 1036 to transmit signals to the server 1014a, smart phone 1014b, and/or main irrigation controller 1012. In addition, the server 1014a and/or the smart phone 1014b are configured to communicate (e.g., send signals to and receive signals from), via the network 1060, access point 1080, and plug in interface device 1070 with the fertigation supply unit 1090, the pump 1048, and the selection manifold 1046 in order to control fertigation as described in more detail below. In some approaches, the main irrigation controller 1012 is optionally configured to communicate directly with the pump 1048, selection manifold 1046, and fertigation supply unit 1090, as shown by way of dashed lines in FIG. 10.

FIG. 11 illustrates another exemplary embodiment of a fertigation system 1100 where the fertigation control unit 14 is in the form of a remote server 1114a and/or a smart phone 1114b (which may be a mobile phone, a tablet, or the like) that can be communicatively coupled via a wireless connection over a network 1160 (which may be wired or wireless) and via a plug-in wireless adapter 1170 to the main irrigation controller 1112. In other words, similarly to the embodiment shown in FIG. 10, in this embodiment, instead of a stand-alone fertigation control unit 14 as in FIG. 1, the fertigation system 1100 is configured to enable a remote server 1114a and/or a remote smart phone 1114b to perform the functions of the fertigation control unit 14 and control the fertigation functions of the system 1100. In this embodiment, the main irrigation controller 1112 includes at least one module mounting location 1140 configured to accommodate the docking and electrical coupling of the plug-in wireless adapter 1170.

In some embodiments, the plug-in wireless adapter 1170 includes transceivers to communicate using well known Bluetooth (Bluetooth Low Energy (BLE)), wireless fidelity (e.g., WiFi) and long-range (e.g., LoRa,m LoRaWAN) standards. LoRa uses direct sequence spread spectrum (DSSS) signaling. For example, the plug-in wireless adapter 1170 can communicate via a wireless connection 1177 such as Bluetooth (Bluetooth Low Energy (BLE)) or WiFi with a local mobile device (e.g., smart phone 1114c, tablet, etc.) running a fertigation/irrigation control application. The plug-in wireless adapter 1170 can also communicate with the remote server 1114a and remote smart phone 1114b (or tablet, etc.) using WiFi and a local wireless router 1175 and access point 1180. In some embodiments, the plug-in wireless adapter 1170 communicates with a variety of local, on-site sensors (e.g., air temperature sensor 1132, soil temperature sensor 1136, or the like) using a wireless connection 1173 such LoRa (alternatively, WiFi may be used). In some embodiments, the plug-in wireless adapter 1170 can communicate using a wireless connection 1171 with various components of the fertigation system 1100 (e.g., fertigation supply unit 1190, pump 1148, selection manifold 1146, etc.), which may be coupled to the wireless router 1175, or may have their own internal wireless adapters.

In some embodiments, the plug-in wireless adapter 1170 can create a local wireless network (e.g., a Wi-Fi network that conforms to the 802.11 standards), and the local smart phone 1114c can communicate with the plug-in wireless adapter 1170 via this local network. In some aspects, the remote server 1114a is permitted to interact with the main irrigation controller 1112 via the plug-in wireless adapter 1170, giving the remote server 1114a the functionality of a fertigation control unit akin to the fertigation control unit 14 in FIG. 1. In some aspects, the remote smart phone 1114b and the local smart phone 1114c can each include an application which allows the user of the smart phone 1114b to interact with the main irrigation controller 1112 via the plug-in wireless adapter 1170, giving the smart phone 1114b the functionality of a fertigation control unit akin to the fertigation control unit 14 in FIG. 1. Although not depicted in FIG. 11, the plug-in wireless adapter 1170 can communicate with other components of the irrigation system (e.g., air temperature sensor 1132, soil temperature sensor 1136, pump 1148, selection manifold 1146, fertigation supply unit 1190, flow sensor, etc.) configured to use a wireless communication protocol compatible to the one used by the plug-in wireless adapter 1170.

In some embodiments, the plug-in wireless adapter 1170 can be completely configured while communicating directly with the remote server 1114a and/or remote smart phone 1114b and/or local smart phone 1114c. For example, the user of the remote server 1114a and/or remote smart phone 1114b and/or local smart phone 1114c can configure all parameters and all settings of the plug-in wireless adapter 1170 (i.e., not only an initial setup of the plug-in interface device 1170, but also perform all other functions described herein, such as configuring fertigation programs) while communicating between the remote server 1114a and/or remote smart phone 1114b and/or local smart phone 1114c and the plug-in wireless adapter 1170. During configuration, the remote server 1114a and/or remote smart phone 1114b and/or local smart phone 1114c can provide the plug-in wireless adapter 1170 with user information which can include a user-defined password. The plug-in wireless adapter 1170 may later require communications transmitted to the plug-in wireless adapter 1170 to include the password. The remote server 1114a and/or smart phone 1114b can also provide network information (for later communication via a network, such as a local area network) to the plug-in wireless adapter 1170.

In some embodiments, if communicating according to a Wi-Fi standard, the remote server 1114a and/or remote smart phone 1114b and/or local server 1114c can provide the plug-in wireless adapter 1170 with a service set identifier (SSID) and key associated with an access point 1180. In some embodiments, the access point 1180 accesses a wide area network (“WAN”) (e.g., the Internet) via the communications network 1160 (optionally, via a modem). Once connected to the access point 1180, the plug-in wireless adapter 1170 is addressable via the access point 1180 and wireless router 1175 by the remote server 1114a and/or remote smart phone 1114b from remote locations.

The plug-in wireless adapter 1170 can also transmit information (e.g., notifications, alerts, other data, etc.) to the server 1114a and/or smart phone 1114b via the wireless router 1175, access point 1180 and network 1160. In some aspects, the access point 1180 transmits, via the wireless router 1175, messages to the plug-in wireless adapter 1170 based on communications between the remote server 1114a and remote smart phone 1114b and the access point 1180. The access point 1180 can also transmit messages from the plug-in wireless adapter 1170 based on the communications via the wireless router 1175 between the air temperature sensor 1132, soil temperature sensor 1136, pump 1148, selection manifold 1146, fertigation supply unit 1190, and main irrigation controller 1112, and access point 1180.

In the embodiment shown in FIG. 11, the plug-in wireless adapter 1170 includes a connector 1172 configured to mate with the module mounting location 1140 to mount the plug-in wireless adapter 1170 to the main irrigation controller 1112. The connector 1172 can include pins that carry data signals from the remote server 1114a and/or remote smart phone 1114b to the main irrigation controller 1112 and vice versa. While one module mounting location 1140 has been shown in FIG. 11, it is to be appreciated that the main irrigation controller 1112 may include a plurality of module mounting locations 1140. The module mounting location 1140 may be accessible from the exterior of the housing of the main irrigation controller 1112, or may be located in the interior of the housing of the main irrigation controller 1112 such that the mounting of the plug-in wireless adapter 1170 to the main irrigation controller 1112 would require removal of one or more panels on, or partial disassembly of, the main irrigation controller 1112.

In some embodiments, the connector 1172 permits the remote server 1114a and/or remote smart phone 1114b and/or local smart phone 1114c to send signals to and/or receive signals from the main irrigation controller 1112. For example, the remote server 1114a and/or remote smart phone 1114b and/or local smart phone 1114c can send a signal through the connector 1172 and the module mounting location 1140 to the main irrigation controller 1112. It is to be appreciated that such a signal can be generated in response to an input such as a command entered manually by a user via the user interface (e.g., a mobile app) installed on the remote smart phone 1114b and/or an input such as a command initiated at the remote server 1114a.

As shown in FIG. 11, the plug in wireless adapter 1170 permits air temperature sensor 1132 and soil temperature sensor 1136 to transmit signals via the wireless connection 1173 to the remote server 1114a, remote smart phone 1114b, and/or main irrigation controller 1112. In addition, the remote server 1114a and/or remote smart phone 1114b are configured to communicate (e.g., send signals to and receive signals from), via the network 1160, access point 1180, and plug-in wireless adapter 1170 and via the wireless connection 1171 with the fertigation supply unit 1190, pump 1148, and selection manifold 1146 in order to control fertigation as described in more detail below. In some approaches, the main irrigation controller 1112 is optionally configured to communicate directly with air temperature sensor 1132 and soil temperature sensor 1136, as shown by way of dashed lines in FIG. 11.

In the embodiment illustrated in FIG. 1, the fertigation control unit 14 has an air temperature input provided via a connection 30 by an air temperature sensor 32. It will be appreciated that the connection 30 can be wired or wireless communication and that the air temperature sensor 32 can be configured to measure ambient air temperature. In one approach, the air temperature sensor 32 includes circuitry and a transmitter configured to send signals to the fertigation control unit 14. The air temperature sensor 32 can be programmed to perform air temperature measurements at predetermined intervals or continuously, and to send signals including air temperature measurement data at predetermined intervals, or in real-time to the fertigation control unit 14.

The fertigation control unit 14 also has a soil temperature input provided via a connection 34 by a soil temperature sensor 36. It will be appreciated that the connection 34 can be wired or wireless. The soil temperature sensor 36 can be above ground or subterranean to measure the soil/ground temperature. In one approach, the soil temperature sensor 36 includes circuitry and a transmitter configured to send signals to the fertigation control unit 14. The soil temperature sensor 36 can be programmed to perform soil temperature measurements at predetermined intervals or continuously, and to send signals including soil temperature measurement data at predetermined intervals, or in real time, to the fertigation control unit 14. In some embodiments, the fertigation control unit 14 is coupled to one or more sensors or remote computers configured to provide calendar and weather data to the fertigation control unit 14.

In the embodiment illustrated in FIG. 1, downstream of the water supply 18, but upstream of the master valve 19, the system 10 includes a flow sensor 41 coupled to the irrigation line 15 and in communication with the fertigation control unit 14 via a connection 43, which can be a wired or a wireless connection. As can be seen in FIG. 1, the system 10 may be set up such that the main irrigation controller 12 is in communication with the flow sensor 41 via a connection 57, which may be a wired or a wireless connection. In one approach, the flow sensor 41 includes circuitry and a transmitter configured to send signals to the fertigation control unit 14, as discussed in more detail below.

In the embodiment shown in FIG. 1, the fertigation control unit 14 is coupled (via a wired or wireless connection 53) to a selection manifold 46 and/or a pump 48. In FIG. 1, the selection manifold 46 is in turn coupled via a connection 50 to the pump 48,which is in turn coupled, via a shut-off valve 49 and a mixing chamber 52, to the irrigation line 15. In one approach, the mixing chamber 52 includes at least one sensor configured to detect (in real-time or at predetermined intervals) the presence of/volume of the fertigation components (e.g., one or more fertilizer component, herbicide, and/or insecticide, etc.) within the mixing chamber 52, and to send signals to the fertigation control unit 14.

While the exemplary system 10 is depicted in FIG. 1 with a pump 48 that is located between the selection manifold 46 and the mixing chamber 52, in some implementations, the pump 48 may be incorporated into physical structure of the fertigation supply unit 700, as shown in FIG. 7. In some approaches, the selection manifold 46 and/or pump 48 includes logic circuitry configured to receive a control signal from the fertigation control unit 14 (e.g., via the wired or wireless connection 53), and to inject the fertilizer components, herbicide, and/or insecticide released from the storage containers 104a-104e of the fertigation supply unit 100 and mixed in the mixing chamber 52 into the irrigation line 15.

As shown in FIG. 1, the fertigation control unit 14 is programmed to send signals in the form of commands directly to the fertigation supply unit 100 via a connection 54, which can be a wired or wireless connection. With reference to FIG. 1, in some embodiments in response to receiving a signal (e.g., an electrical power signal or a data signal) from the fertigation control unit 14, the fertigation supply unit 100 can cause one or more fertilizer components, herbicides and/or insecticides to be released (e.g., through the lines 44a-44e via the action of the selection manifold 46 and/or pump 48) from their respective storage containers 104a-104e of the fertigation supply unit 100 and injected for a prescribed/calculated time duration via the connection 50 into a mixing chamber 52 for mixing prior to being released from the mixing chamber 52 and into the irrigation water line 15.

FIG. 7 depicts an exemplary fertigation supply unit 700 usable with the fertigation system 10. For purposes of this application, an “fertigation supply unit” will be understood as a structure which, alone, or when coupled to other structures, receives a signal from the fertigation control unit 14 and causes one or more fertilizer components (e.g., nitrogen, phosphorus, potassium, and/or their derivatives, or the like), herbicide, and/or insecticide to be injected into the irrigation line 15 of the fertigation system 10. In some embodiments, the fertigation supply unit 100 includes, or is coupled to, an electrical input and/or logic circuitry configured to receive a power signal and/or data signal from the fertigation control unit 14. In some embodiments, the fertigation supply unit 700 can include a simple valve or other structure that opens and closes based on receiving a power signal from the fertigation control unit 14 (e.g., such as found in a venturi pump or in connection with a pressurized container).

In some embodiments, the fertigation supply unit 100 also includes, or is coupled to, one or more structures configured to store one or more fertilizer components, herbicides, and insecticides, or mixtures thereof. The fertigation supply unit 700 of FIG. 7 includes a housing 702 and storage containers 704a-704e located at least in part within the housing 702. It is to be appreciated that the storage containers 704a-704e can be located entirely within the housing 702, partly within the housing 702, or entirely outside of the housing 702. For example, the storage containers 704a-704e may be physically separate from the housing 702 of the fertigation supply unit 700 and connected by one or more connections (e.g., pipes) to the housing 702 of the fertigation supply unit 700.

In one approach, the housing 702 of the fertigation supply unit 700 is a valve box. The storage containers 704a-704e may have a capacity of between about 1-10 gallons and can include a spout with a removable cap that allows a user such as a homeowner or a contractor to easily replenish the level of the fertilizer component, herbicide, and/or insecticide in the storage container 704a-704e. In some approaches, the storage containers 704a-704e are pressurized containers with Poke Yoke lids that may be connected directly to a connection (e.g., pipe) coupled to the irrigation water line 15.

In some embodiments, the fertilizer components stored in the storage containers 704a-704c are liquid nitrogen solution, phosphorus (e.g., phosphorus solution, soft rock phosphate, or bone meal), and liquid potassium solution with chelated iron (e.g., potassium carbonate, potassium chloride, potassium sulfate, potassium nitrate, etc.), the herbicide stored in the storage container 704d is selected from, for example, 24-D, Atrazine, Clopyralid, Metoalachlor, or the like, and the insecticide stored in the storage container 704e is selected from, for example, organochlorides (e.g., DDT), malathion, carbamates, pyrethroids, neonicotinoids, ryanoids, or the like. Preferably, the fertilizer components, herbicides, and/or insecticides in the storage containers 704a-704e are non-toxic, biodegradable, and environmentally safe.

With further reference to the embodiment of FIG. 7, the fertigation supply unit 700 includes a valve selection manifold 746 and a pump 748 positioned at least in part within the housing 702. It is to be appreciated that the pump 748 can be located entirely within the housing 702, partly within the housing 702, or entirely outside of the housing 702. In one form, the pump 748 is a chemical metering pump, in another form, a variable speed chemical metering pump. It is to be appreciated that instead of a metering pump, the pump 748 can be any other suitable pump or pressurized source capable of causing the fertilizer components, herbicides, and insecticides in the storage containers 704a-704e be injected into the irrigation water line 15.

In one aspect depicted in FIG. 7, the pump 748 is connected to the storage containers 704a-704e via the selection manifold 746 and one or more delivery lines 707a-707e. In some aspects, the selection manifold selectively permits flow only through the delivery lines 707a-707e that were selected by the fertigation control unit 14 for injection into the irrigation line 15. It is to be appreciated that the pump 748 can be connected to the storage containers 704a-704e in other ways and may be entirely absent from the fertigation supply unit 700 and may be internal to the mixing chamber 52, or may be a stand-alone structure positioned between the selection manifold 46 and the mixing chamber 52 as shown in FIG. 1. The pump 748 of the fertigation supply unit 700 of FIG. 7 further includes a second delivery line 709 which can be connected, for example, via the mixing chamber 52 (see FIG. 1) to the irrigation line 15 in order to deliver, into the irrigation line 15, one or more fertilizer components, herbicides, and/or insecticides released from their respective storage containers 704a-704 via the selection manifold 746. In some embodiments, instead of a single delivery line 709, the fertigation supply unit 700 could have five delivery lines akin to the lines 44a-44e of FIG. 1 (which are each associated with their respective storage containers 104a-104e) downstream of the pump 748.

In one approach, the selection manifold 746 and/or pump 748 of the fertigation supply unit 700 includes or is coupled to logic circuitry/processor 749 (which may be coupled to a power supply 753 and a memory 755) configured to receive power and/or data signals (e.g., via input/output 751) from any one of the fertigation control units 14, 114, 214, 314, and 414, and, in response to the received signals, to cause at least some of the fertilizer components, herbicides, and/or insecticides to be ejected (i.e., selectively) from the storage containers 704a-704e and into the irrigation water line 15. In another approach, the fertigation supply unit 700 can include an input 751 implemented into, or electrically coupled to the pump 748, that can receive an electrical signal (e.g., an A/C power signal) from the fertigation control unit 14 that would cause the pump 748 to inject at least some of the fertilizer components, herbicides, and/or insecticides into the main line 15. In yet another approach, the fertigation supply unit 700 can be configured such that it lacks the pump 748, and such that the storage containers 704a-704e are pressurized containers (e.g., with Poke Yoke lids) configured to, upon the opening of a valve, to deliver the fertilizer components, herbicides, and/or insecticides stored therein to the irrigation water line 15.

Generally, in some embodiments, based on at least one of time of year calendar data, weather data, historical air temperature values, and historical soil temperature values stored in the fertigation control units 14, 114, 214, 314, and 414, as well as based at least on air temperature data received by the fertigation control units 14, 114, 214, 314, and 414 from at least one air temperature sensor 32 and/or soil temperature data received by the fertigation control units from at least one soil temperature sensor 36, the processors 16, 116, 216, 316, and 416 of the fertigation control units 14, 114, 214, 314, and 414 fertigation control units are configured to determine an optimal time for initiating injection of at least some of the at least one of the fertilizer component(s), herbicide(s), and insecticide(s) into the irrigation line 15, as well as optimal delivery quantities and/or relative amounts of the fertilizer components, herbicide, and insecticide from the storage containers 104a-104e into the irrigation line 15.

In one approach, the processors 16, 116, 216, 316, and 416 of the fertigation control units 14, 114, 214, 314, and 414 are programmed to analyze trends in data received from the air temperature sensor 32 and the soil temperature sensor 36. To that end, the memory 20, 120, 220, 320, and 420 of each fertigation control unit 14, 114, 214, 314, and 414 can include stored historical values and trends of air temperatures and ground temperatures associated with the geographical location (for example, based on zip code) where the fertigation system 10 is located. In addition, the memory 20, 120, 220, 320, and 420 of each fertigation control unit 14, 114, 214, 314, and 414 can include predetermined minimum and maximum temperature thresholds, which, when approached, would trigger the fertigation control units 14, 114, 214, 314, and 414 to initiate the seasonal fertigation cycles (i.e., release of one or more of fertilizer components in particular quantities, herbicides, insecticides, etc.), as described in more detail below.

In one approach, the processors 16, 116, 216, 316, and 416 of the fertigation control units 14, 114, 214, 314, and 414 are programmed to analyze the temperature readings received from the air temperature sensor 32 and/or soil temperature sensor 36 over a predetermined time interval (for example twice daily, once daily, every other day, once every two days, once a week, or any other suitable interval). This analysis is performed in view of the air and soil temperature historical trend values, as well as time of year data, to predict whether the air and/or soil temperature trend is approaching the predetermined minimum or maximum fertigation, herbicide, and/or insecticide initiation threshold stored in the memory 20, 120, 220, 320, and 420 of the fertigation control units 14, 114, 214, 314, and 414.

The fertigation control units 14, 114, 214, 314, and 414, in addition to being programmed to measure and respond to trends in temperature, can have specific calendar dates stored in their memories 20, 120, 220, 320, and 420. The specific calendar days (when reached) can cause the fertigation control units 14, 114, 214, 314, and 414 to either initiate the (spring, summer, fall, or winter) fertigation mixture cycle, or to exit the fertigation mixture cycle and return to normal operation of the fertigation system 10. For example only, the fertigation control units 14, 114, 214, 314, and 414 can be programmed with a date of, for example, March 1, March 15, April 1, May 1, May 15, June 1, June 15, September 1, September 15, October 1, October 15, December 1, December 15, etc. on which, regardless of the air/soil temperature trends determined based on temperature sensor input, the fertigation control units 14, 114, 214, 314, and 414 would begin the fertigation cycle (which could be preprogrammed to run for a predetermined period of time, and to apply a set mixture percentage of each of the fertilizer components, herbicides, and/or insecticides.

Similarly, the fertigation control units 14, 114, 214, 314, and 414 can be programmed with a calendar date of, for example, March 15, April 1, May 1, May 15, June 1, June 15, September 1, September 15, October 1, October 15, October 31, December 15, December 31, etc. on which, regardless of the temperature trends, the fertigation control units 14, 114, 214, 314, and 414 would begin to exit from the fertigation cycle and return to the normal irrigation operation of the system 10. In some embodiments, these calendar dates may be stored as a result of manual user input to the fertigation control unit.

In addition, the fertigation control units 14, 114, 214, 314, and 414 can be programmed such that a user such a homeowner or contractor user can override the stored temperature trends and calendar dates and initiate or exit from the fertigation cycle by a manual input. In different embodiments, this manual input from the user can be directly provided at the physical location of the fertigation control units 14, 114, 214, 314, and 414, or remotely, for example, from a central station or a mobile hand-held device. In one approach, to enable reception of remote user inputs, the fertigation control units 14, 114, 214, 314, and 414 include a network card and/or a wireless receiver adapted to receive user input from a remote internet server or a user mobile device via a wired or wireless (e.g., satellite or cellular) connection.

In some embodiments, the processors 16, 116, 216, 316, and 416 of the fertigation control units 14, 114, 214, 314, and 414 are programmed to release certain fertilizer components, herbicides, and insecticides (or combinations thereof) in certain relative amounts based on considerations of when they would be optimally effective to facilitate plant growth/yield, develop root growth/provide drought resistance, and/or would optimally inhibit certain pests or weeds. For example, in some aspects, the processors 16, 116, 216, 316, and 416 of the fertigation control units 14, 114, 214, 314, and 414 may be programmed to release a herbicide (e.g., crab grass preventer in a predetermined amount relative to time of year) from the storage container 104d of the fertigation supply unit 100 to kill weeds/prevent growth of weeds (e.g. crab grass) when the time of year trend indicates that the early spring (e.g., April) rain season is about to begin and the temperature trend indicates several (e.g., two or more consecutive) upcoming days of temperatures between 50-55° F.

Without wishing to be limited to theory, such a treatment would be washed into the soil by the upcoming rain and would prevent the crab grass from germinating when the sustained temperatures go higher to the prescribed crab grass based germination temperatures (e.g., 57-65° F). . In some embodiments, the main irrigation controller 12 is programmed to interrupt the irrigation cycle during the early spring rain season herbicide application. Notably, if the herbicide were to be applied too early in the spring, the herbicide may undesirably break down and become ineffective before the crab grass germination cycle.

In some aspects, the processors 16, 116, 216, 316, and 416 of the fertigation control units 14, 114, 214, 314, and 414 may be programmed to release an insecticide (e.g., organophosphorus) from the storage container 104e of the fertigation supply unit 100 to prevent spread of harmful insects (e.g. moths, ants, grubs, etc.) when the time of year trend indicates that the spring rain season is over. Without wishing to be limited to theory, insecticide treatment prior to rain season may not be desirable, since the rain water may pick up and carry the dispensed insecticide well beyond the desired treatment area, which may be undesirable.

As mentioned above, the fertigation system 10 described herein is configured to dispense one or more fertilizers from the storage containers 104a-104c of the fertigation supply unit 100. Generally, fertilizers enhance the growth of plants by providing nutrient-containing additives and/or by enhancing the effectiveness of the soil by modifying its water retention and aeration. The most common macronutrients applied during fertilization are nitrogen (which facilitates, for example, leaf growth), phosphorus (which is beneficial for drought resistance, stimulated root growth, increased stalk and stem length and improved flower formation), and potassium (which facilitates stem growth, plant strengthening, protection from cold and dry weather, retaining of water in plants, and growth of flowers and fruits). Other macronutrients (e.g., calcium, magnesium, sulfur) are also commonly used. In addition, various micronutrients (boron, cobalt, copper, iron, manganese, molybdenum, silicon, vanadium, and zinc) may also be used. Multi-nutrient fertilizers are very widely used, with the most common being NPK fertilizers, which are three-component fertilizers including nitrogen, phosphorus, and potassium.

NPK fertilizers are typically classified using the NPK rating system, which identifies the amount of nitrogen, phosphorus, and potassium in a fertilizer. Generally, an NPK rating has three numbers separated by dashes (e.g., 10-10-10 or 16-4-8) describing the chemical content of fertilizers, with the first number representing the percentage of nitrogen (e.g., by way of ammonia or related compounds, urea, etc.) in the product, the second number representing the percentage of phosphorus (e.g., by way of superphosphates such as P₂O₅) in the product; and the third number representing the percentage of potassium (e.g., by way of K₂O, commonly referred to as potash). For example, a 50-pound (23 kg) bag of fertilizer labeled 16-4-8 contains 8 pounds (3.6 kg) of nitrogen (i.e., 16%), 2 pounds of phosphorus (4%), and 4 pounds of potassium (8%), thus comprising the active ingredients. The remaining percentage of the weight of the bag, i.e., contains inactive ingredients like clay and/or organic matter.

It is generally understood that the time of year and seasons (i.e., spring, summer, fall, winter) has a direct relationship to plant growth and reproduction. Accordingly, different seasons typically call for different combinations and amounts of fertilizer to be applied. Without wishing to be limited to theory, after being mostly dormant during the winter, plants excel in top growth in the spring, and it is common to fertilize using all three macronutrients (i.e., nitrogen, phosphorus, potassium) in the spring, but in a specific combination of NPK that emphasizes nitrogen and potassium. For example, a spring fertilization would normally have an NPK rating of 32-0-4. This would be applied at 2.5 pounds total per 1,000 square feet. Of this total material applied, it comprise 0.8 pounds nitrogen and its derivatives, 0 pounds phosphorus, 0.1 pounds potassium and its derivatives, and optionally 0.1 pounds of residual sulfur (e.g., 4%), which aids in the slower release of nitrogen. i

Generally, many cool season grasses, which generally grow better in the spring and early fall, are dormant in the summer and winter need more phosphorus and potassium with small amounts of nitrogen, while warm season grasses (which generally grow from beginning of spring to the beginning/middle of fall and are dormant in the winter) require an application of fertilizer in the summer to sustain this growth and to remain healthy. In one example, a summer fertilization would normally have an NPK rating of 16-4-8. This too may be applied at a rate of 2.5 pounds per 1,000 square feet. Of the total applied material, it may comprise 0.4 pounds nitrogen and its derivatives, 0.1 pounds of phosphorus, 0.2 pounds of potassium and its derivatives and optionally 0.1 pounds residual sulfur (4%) to aid in the slower release of nitrogen.

Generally speaking, in some climates and locations a preferred time to fertilize some cool weather grasses is during the fall, such that the weather grasses may be aided in their ability to resist winter weeds and increase their density and color, thereby facilitating spring recovery. In some embodiments, a typical fall fertilization would utilize a fertilizer with an NPK composition of 12-4-8. Basically, the purpose of the fall application of fertilizer is to aid in root development while minimizing top growth, but developing the inner structure of the grass blade and gaining a rich deep green color and increasing the density.

In some embodiments, the processors 16, 116, 216, 316, and 416 of the fertigation control units 14, 114, 214, 314, and 414 are programmed to determine that the time of year data and the air and/or soil temperature data received over a predetermined time period from the air temperature sensor 32 and/or soil temperature sensor 36 indicates a predictable trend that the air temperature will soon reach optimal spring temperatures for growth of a desired lawn/plant, and to then initiate a fertilizer treatment that would be optimal to promote spring growth/yield of the desired lawn/plant.

In some aspects, the processors 16, 116, 216, 316, and 416 of the fertigation control units 14, 114, 214, 314, and 414 are programmed, in response to a determination by the processors that the time of year data and the air temperature data received over a predetermined time period from the air temperature sensor 32 and/or soil sensor 36 indicates a predictable trend that the air temperature will soon reach an optimal spring temperature for growth of a desired lawn/plant, to then initiate a fertilizer treatment for a predetermined period of time (e.g., 1 day, 3 days, 7 days, 2 a weeks, etc.) that would be optimal to promote spring growth/yield of the desired lawn/plant.

The treatment may be initiated by the processors 16, 116, 216, 316, and 416 of the fertigation control units 14, 114, 214, 314, and 414 sending a signal to the fertigation supply unit 100 to dispense a higher concentration of nitrogen than phosphorus and potassium and more potash than phosphorus (e.g., a mixture of 20% nitrogen from container 104a, 5% phosphorus from container 104b, and 10% potash from container 104c) to facilitate spring lawn/plant growth. In one example, an early spring fertilization cycle may include the application of a fertilizer having a nitrogen content of about 28% and low potash (helps with drought resistance) and low phosphorus (helps with root development), followed by application of a preemergent (i.e., herbicide such as a crab grass preventer). In some aspects, in late spring (e.g., may 1-31), only herbicide is applied to certain plants/flowers (e.g., dandelions, broad leaf plants, etc.) out of direct sunlight while no fertilizer is applied.

In some aspects, the processors 16, 116, 216, 316, and 416 of the fertigation control units 14, 114, 214, 314, and 414 are programmed, in response to a determination by the processors that the time of year data and the air and/or soil temperature data received over a predetermined time period from the air temperature sensor 32 and/or soil temperature sensor 36 indicates a predictable trend that the air temperature will soon reach optimal summer temperatures for growth of a desired lawn/plant, as well as broadleaf weeds, to then initiate a fertilizer and herbicide based treatment for a predetermined period of time (e.g., 1 day, 3 days, 7 days, 2 weeks, etc.) that would be optimal to promote summer growth/yield of the desired lawn/plant. The treatment may be initiated by the processors 16, 116, 216, 316, and 416 of the fertigation control units 14, 114, 214, 314, and 414 sending a signal to the fertigation supply unit 100 to dispense less nitrogen than in the spring, but less phosphorus and potash than in the spring (e.g., a mixture of 16% nitrogen from container 104a, 4% phosphorus from container 104b, and 8% potash from container 104c) to protect the lawn/plant from periods of higher temperature and drought conditions.

Generally, during the fertigation cycle of the exemplary system 10 depicted in FIG. 1, the fertigation control unit 14 sends data and/or power signals to the fertigation supply unit 100 to activate the supply of one or more of the fertilizer components, herbicides, and insecticides from storage containers 104a-104e into the irrigation water line 15 and subsequent lateral lines 22a, 22b, and 22c. In some embodiments, when the fertigation supply unit 700 depicted in FIG. 7 receives the signals from the fertigation control unit 14, the pump 748 and/or selection manifold 746 of the fertigation supply unit 700 becomes activated and causes the injection of one or more of the fertilizer components, herbicides, and insecticides from the storage containers 104a-104e into the irrigation water line 15 for a prescribed amount of time to meet the application requirements of the three main components of the fertilizer.

When the fertilizer components, herbicides, and/or insecticides from storage containers 104a-104e fill the irrigation water line 15 and lateral lines 22a, 22b, and 22c (which may be detectable by flow rate/line length calculation or a change in pressure resulting from a change in fluid density being emitted from spray heads), the pump 748 of the fertigation supply unit 700 can be deactivated to stop the injection of the fertilizer components, herbicides, and/or insecticides into the irrigation line 15. For example, when the processor 16 of the fertigation control unit 14 determines that the desired amount of the fertilizer components, herbicides, and/or insecticides has been dispensed onto the greenscape via the sprinklers 25a-25c, the processor 16 may cause the fertigation control unit 14 to send a signal (e.g., a power signal or a data signal) to the fertigation supply unit 700 to deactivate the pump 748 and/or selectin manifold 746. As mentioned above, the fertigation control unit 14 can include a visual indicator that indicates to a user that the fertilizer components, herbicides, and/or insecticides are being or have been injected and are traversing the irrigation water line 15 and subsequent lateral lines 22a, 22b, and 22c.

In one aspect, the fertilizer components, herbicides, and/or insecticides are introduced from the storage containers 104a-104e of the fertigation supply unit 100 into the irrigation water line 15 for a prescribed amount of time until the concentration/amounts of the fertilizer components, herbicides, and/or insecticides determined based the input area of vegetation by the processors 16, 116, 216, 316, and 416 of the fertigation control units 14, 114, 214, 314, and 414 to be appropriate/optimal for given geographic location/time of year/weather conditions based on analyzed/expected air and/or ground temperatures are reached.

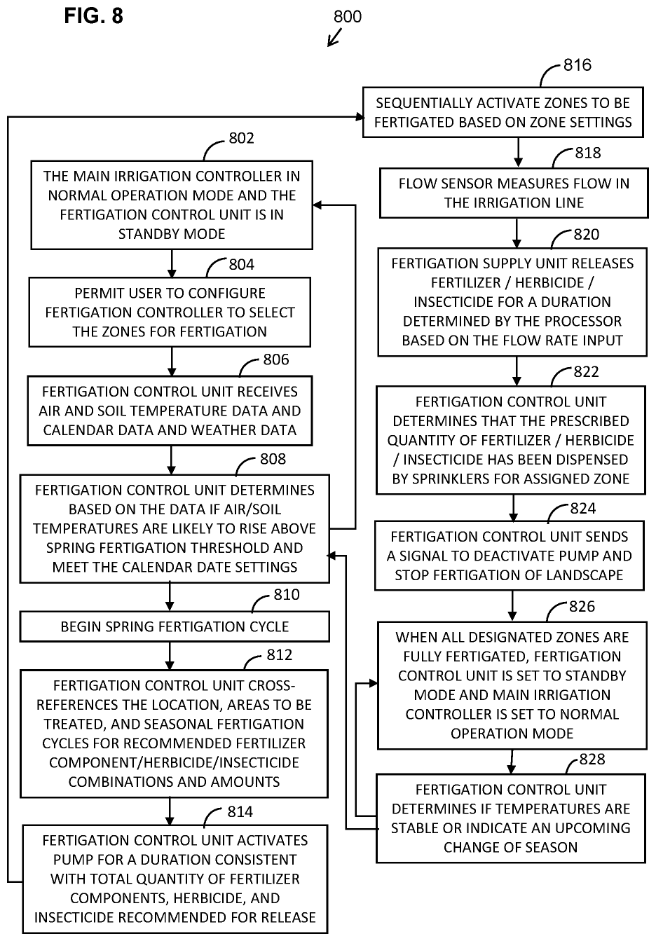

With reference to FIGS. 1 and 8, one method 800 of operation of the fertigation system 10 will now be described. While reference will be made to the fertigation control unit 14 of FIG. 1, it is to be appreciated that this exemplary method of operation of the fertigation system 10 can be likewise controlled by any of the fertigation control units 114, 214, 314, and 414.

With reference to FIG. 8, during the late winter (e.g., end of February-early March), when the air and ground temperatures are still too cold for lawn/plants to grow, the main irrigation controller 12 is in a normal operation mode, as in step 802. In step 802, with the main irrigation controller 12 being in the normal operation mode, the master valve 19 is open, the irrigation line 15 receives input from the water supply 18, but the fertigation control unit 14 is in standby mode. As can be seen in FIG. 8, with the fertigation control unit 14 being in standby mode, the fertigation control unit 14 is programmed to permit normal irrigation operation controlled by the main irrigation controller 12.

In some embodiments, a user may use the user interface of the fertigation control unit 14 and/or the user interface of the main irrigation controller 12 to manually and selectively preset one or more of the irrigation zones 22a-22c associated with the zone valves 24a-24c for fertigation. For example, if the user determines that, for example, the sprinklers 25b controlled via the zone valve 24b are located in an irrigation zone 22b, where fertigation should not be applied for one or more reasons, the user can manually configure the fertigation cycle to skip over the zone valve 24b, such that zone valve 24b and its associated sprinklers 25b would not turn on during the fertigation cycle, and instead the fertigation cycle will start with the zone valve 24a, and would then skip over the zone valve 24b, such that the next zone valve that would be sequentially activated in the fertigation cycle after the zone valve 24a would not be the zone valve 24b, but would be the zone valve 24c.

To facilitate sequential activation of user-pre-selected fertigation zones/zone valves 24a-24c, in the illustrated embodiment, the method 800 includes step 804, where a user is permitted to configure the fertigation control unit 14 to select which zones of the area to be treated will be activated (and, by the same token, to select which zones of the area to be treated will not be activated) during the fertigation cycle. It will be appreciated that step 804 is optional in certain embodiments, where the fertigation control unit 14 may be preset to a default setting where each one of the zone valves (e.g., 24a, 24b, and 24c) in communication with the fertigation control unit 14 and/or main irrigation controller 12 is sequentially activated for fertigation.

As discussed above and depicted at step 806, the fertigation control unit 14 periodically receives calendar data and weather data, as well as ambient air temperature data and soil/ground temperature data at predetermined time intervals from the air temperature sensor 32 and the soil temperature sensor 36, respectively. At step 808, the processor 16 of the fertigation control unit 14 can access the time of year data and historical air/soil temperature trends stored in the memory 20 and determine, given the given geographic location and the time of year, whether the trend in the received air/soil temperature readings is such that the air/soil temperature is likely to approach and/or rise above the predetermined air/soil temperature threshold (e.g., 50-55° F. or 10-12.8° C.) and meet the calendar date settings associated with an initiation of spring fertigation stored in the memory 20 of the fertigation control unit 14. It is understood that the minimum spring fertigation initiation threshold is preferably below the temperatures at which weeds begin to germinate and at the temperatures, where lawns/plants transition from their winter dormancy to their spring growth spurt.

If the air/soil temperatures are determined by the fertigation control unit 14 at step 808 to be below the predetermined minimum threshold, the main irrigation controller 12 continues to operate in its normal operation mode, shown by the arrow going from step 808 back to step 802 in FIG. 8. If, however, the fertigation control unit 14 determines, at step 808, that the air/soil temperatures are at or higher than the lower predetermined fertigation temperature threshold and meet the calendar date settings, the fertigation control unit 14, at step 810, begins the execution of the spring fertigation cycle. If the fertigation control unit 14 includes a visual indicator to alert the user that the fertigation cycle has been initialized, at step 810, the fertigation control unit 14 also causes the visual indicator (e.g., an LED light) to be illuminated. In another approach, the visual indicator is a message on (an optional) of the fertigation control unit 14, or an audible alarm signal.

At step 812, in some embodiments, the processor 16 of the fertigation control unit 14 cross-references one or more of the geographic location (e.g., address, zip code, etc.), the area(s) to be fertigated (e.g., grass type), and the seasonal fertigation cycles to determine recommended combinations and amounts of the fertilizer component, herbicide and/or insecticide. In one approach, the combinations and amounts of the fertilizer components, herbicide and/or insecticide to be dispensed are determined by the processor 16 of the fertigation control unit 14 to be optimal based on the geographic location of the grass area to be treated, as well as the time of year data stored in the fertigation control unit 14 and the air and/or soil temperature data received over a predetermined time period from the air temperature sensor 32 and/or soil temperature sensor 36, and based on the needs of the vegetation fertigated by the system 10.

In another approach, the combinations and amounts of the fertilizer component, herbicide and/or insecticide are preset by a user using the user interface of the fertigation control unit 14 (e.g., based on the time of year and/or geographic location and area of the vegetation irrigated/fertigated by the system 10) and stored in the memory 20 of the fertigation control unit 14. Then, at step 814, the fertigation control unit 14 activates the pump 748 for a duration of time consistent with sequentially releasing the total quantity of fertilizer components, herbicides, and insecticides recommended by the processor 16 for fertigation treatment in one or more of the user-pre-selected (or fertigation control unit 14 pre-selected) irrigation zones 22a, 22b, and 22c coupled to the zone valves 24a, 24b, and 24c, respectively.

Then, at step 816, the fertigation control unit 14 sequentially activates one or more of the irrigation zones 22a, 22b, and 22c (depending on which of the irrigation zones 22a-22c were pre-selected by the user using the user interface of the fertigation control unit 14 (or factory pre-programmed into the fertigation control unit 14) to be activated during the fertigation cycle) to permit the release of the total quantity of fertilizer components, herbicides, and insecticides determined by the processor 16 of the fertigation control unit 14 at step 812 to be appropriate for releasing in the irrigation zones 22a, 22b, and 22c. In some embodiments, in connection with the activation of the irrigation zones 22a, 22b, and 22c, the fertigation control unit 14 sends an activation signal (e.g., an electrical power signal or a data signal) via connection 54 to an input 751 of the fertigation supply unit 700 to activate the selection manifold 746 and/or the pump 748 (see FIG. 7), or via connection 53 to an input of logic circuitry that controls the selection manifold 46 and/or pump 48 coupled to the mixing chamber 52 (see FIG. 1).

With further reference to FIG. 8, in step 818, the flow sensor 41 (which, as mentioned above with reference to FIG. 1, communicates via a (wired or wireless) connection 43 with the fertigation control unit 14) measures the flow in the irrigation line 15 both prior to and after the fertilizer components, herbicides and/or insecticides released from the fertigation storage containers 104a, 104b, 104c, 104d, and/or 104e of the fertigation supply unit 100 flow through the irrigation line 15.

As mentioned above, in some embodiments, the main irrigation controller 12 is configured for sending signals to the flow sensor 41 via a connection 57 (which may be wired or wireless). As shown in step 820 in FIG. 8, this activation signal causes the fertigation supply unit 100 or 700 to release for a duration determined by the processor 16 of the fertigation control unit 14 based on flow rate input and consistent with the values obtained from the memory 20 of the fertigation control unit 14, one or more of fertilizer components, herbicides and/or insecticides from the storage containers 104a-104e or 704a-704e, into the irrigation line 15, via the shut-off valve 51 and the mixing chamber 52 as shown in FIG. 1, or directly, if the storage containers 104a-104e are coupled directly to the irrigation line 15 without a mixing chamber 52 between the storage containers 104a-104e and the irrigation line 15. In some embodiments, the fertigation supply unit 100 dispenses the fertilizer components, herbicides and/or insecticides into the irrigation line 15 for a prescribed duration of time given the flow rate of the greenscape until the amounts of the fertilizer components, herbicides and/or insecticides determined (as described above) by the processor 16 of the fertigation control unit 14 to be optimal for dispensing in a given geographical location during this fertigation cycle have been dispensed by the sprinklers 25a-25c of each irrigation zone 22a-22c.

As mentioned above, in some implementations, the activation signal from the fertigation control unit 14 is generated by the processor 16 and sent via the connection 54 to a logic circuitry located within the pump 748 of the fertigation supply unit 700, with the logic circuitry being adapted to interpret this signal and initiate the injection of the fertilizer components, herbicides and/or insecticides from one or more of the fertigation storage containers 104a-104e of the fertigation supply unit 100 via the selection manifold 746 into the irrigation water line 15. In another approach, the signal from the fertigation control unit 14 is generated by the processor 16 and is sent via connection 53 to a logic circuitry located away separate from the pump 748, for example, the logic circuitry coupled to the pump 748, or to an electrical input directly coupled to the pump 748, or via an intermediate device.

As mentioned above and with reference to step 818, flow in the irrigation line 15 is measured using the flow sensor 41. The flow sensor 41 can include circuitry and a transmitter configured to transmit the flow rates (e.g., of water) measured in the irrigation line 15 to the fertigation control unit 14. The fertigation control unit 14 is programmed to interpret the information received from the flow sensor 41 regarding the flow rate in the irrigation line 15 to determine a desired duration time of operation for introducing the fertilizer components, herbicides and/or insecticides from the fertigation storage containers 104a, 104b, 104c, 104d, and/or 104e of the fertigation supply unit 100 into the irrigation line 15. As mentioned above, the fertigation control unit 14 can include a visual indicator in the form of an LED light or an on-screen message that indicates whether the spring fertigation mode is on or off.

With reference back to FIG. 8, at step 822, the processor 16 of the fertigation control unit 14 determines that the desired total amount/concentration of the fertilizer components, herbicides and/or insecticides released from the fertigation storage containers 104a-104e has been reached in all configured irrigation zones 22a, 22b, and 22c, and that the amount of fertilizer components, herbicides, and/or insecticides determined by the processor 16 to be dispensed onto the greenscape has been dispensed via the sprinklers 25a-25c (this can be calculated by the processor 16, for example, by factoring the flow rate and time duration and required component concentration needed for the landscape at the prescribed time period).

In response to the determination by the processor 16 at step 822 that all of the irrigation zones that were fertigated (as a result of being manually selected by the user for fertigation or as a result of being factory pre-programmed into the fertigation control unit 14), the fertigation supply unit 100 can be deactivated (to stop the injection of the fertilizer components, herbicides and/or insecticides into the irrigation line 15). In the exemplary embodiment of FIG. 8, this deactivation of the pump 48 or 748 associated with the fertigation supply unit 100 or 700 can be accomplished at step 824 via the fertigation control unit 14 sending a signal to the fertigation supply unit 700 or to the circuitry associated with pump 48.

After the above-described exemplary spring fertigation cycle is complete for the designated zones, the fertigation control unit 14 is preferably set at step 826 to a low power (“sleep”) state designed to consume a minimal amount of power, and the main irrigation controller 12 is returned to normal irrigation mode. Alternatively, a valve could be used to shut off the fertigation supply unit 700. Subsequently, the fertigation control unit 14 can, at predetermined intervals (e.g., 1 week, 2 weeks, 4 weeks, 6 weeks, 8 weeks, 10 weeks, 12 weeks, etc.), emerge from the sleep mode to receive temperature readings of the air and/or ground temperatures from the air temperature sensor 32 and/or soil temperature sensor 36, and send signals containing air temperature and soil temperature data to the fertigation control unit 14.

In some embodiments, using the air/soil temperature data received from the sensors 32 and/or 36, as well as the time of year data, geographic location data, weather data, the historical air/soil temperatures and the air/soil temperature trending algorithm programmed into its processor 16, at step 828, the fertigation control unit 14 determines if the temperature of the fertigation system 10 is stable (indicating that it is still spring), or appearing to migrate toward warmer temperatures consistent with the beginning of summer. If the answer at step 828 is yes, in other words, if the processor 16 predicts that the temperatures are likely to approach one of the pre-defined temperature thresholds associated with the beginning of summer, the logic flow loops back to step 808, but the fertigation control unit 14 now determines whether the air and/or soil temperatures during certain pre-determined calendar dates are expected to exceed the summer fertigation threshold temperatures (e.g., 80-85° F.) indicative of the end of spring and the beginning of summer for fertigation purposes.

If at step 828 the answer is yes, in one approach, the fertigation control unit 14 determines whether the observed upper temperature trend correlates with the system start-up calendar date stored in the memory 20 of the fertigation control unit 14. In such implementations, if the answer at step 828 is no, the fertigation control unit 14 returns to its sleep mode and steps 826 and 828 are repeated at predetermined intervals (e.g., daily, every other day, twice a week, once a week, etc.) until the fertigation control unit 14 determines in step 828 that the upper temperature trend correlates with the stored calendar date for system summer fertigation start-up. As described above, at this time, or at any other time determined by a user such as a homeowner or a contractor, the stored temperature trend indications and calendar dates (e.g., stored based on manual user input or selection) can be overridden to initiate system summer fertigation start-up by a manual input at the location of the fertigation control unit 14, from a central station, or from a mobile central controller.

In some embodiments, when the fertigation control unit 14 determines in step 828 that the upper temperature trend correlates with the stored calendar date for system summer fertigation start-up, the processor 16 of the fertigation control unit 14 is programmed to execute a system summer fertigation start-up, which proceeds akin to the spring fertigation sequence starting at step 810. As pointed out above, since the lawns/plants have different fertilizer component, herbicide, and insecticide needs in the summer as compared to spring (given the air/soil temperature and plant growth/development differences between spring months and summer months), in some embodiments, the processor 16 of the fertigation control unit 14 cross-references the summer values of fertilizer components, herbicide and/or insecticide concentration/relative amounts associated with the location (e.g., address or zip code) where the fertigation control unit 14 is located, as well as the plant species present in the area where fertigation will be utilized.

In one approach, the fertilizer component, herbicide and/or insecticide concentration/relative amount values are determined by the processor 16 of the fertigation control unit 14 to be optimal based on the time of year data (i.e., summer) and weather data stored in the fertigation control unit 14 and the air and/or soil temperature data received over a predetermined time period from the air temperature sensor 32 and/or soil temperature sensor 36 and based on the vegetation irrigated/fertigated by the system 10. In another approach, the fertilizer component, herbicide and/or insecticide concentration/relative amount values are preset by a user (e.g., based on the vegetation irrigated/fertigated by the system 10) and stored in the memory 20 of the fertigation control unit 14. After the amounts of the fertilizer component, herbicide, and/or insecticide to be dispensed during the summer fertigation cycle are determined by the processor 16 of the fertigation control unit 14 akin to step 812 of the spring fertigation start-up sequence, the fertigation control unit 14 activates one or more of irrigation zones 22a, 22b, and 22c coupled to the zone valves 24a, 24b, and 24c, respectively, similar to step 814 of the spring fertigation start-up sequence.

Then, akin to step 816 of the spring fertigation start-up sequence, the fertigation control unit 14 sends an activation signal (e.g., an electrical power signal or a data signal) via connection 53 to an input 751 of the fertigation supply unit 700 to activate the pump 748, or via connection 53 to an input of logic circuitry that controls the pump 48 coupled to the mixing chamber 52 to cause (akin to step 820 of the spring fertigation sequence) the fertigation supply unit 100 or 700 to release, at concentrations/in relative amounts and time durations consistent with the values obtained from the memory 20 of the fertigation control unit 14, and area of vegetation to be treated, one or more of fertilizer components, herbicides and/or insecticides from the storage containers 104a-104e or 704a-704e, into the irrigation line 15 through the selection manifold 46 (through the shut-off valve 51 and via the mixing chamber 52 as shown in FIG. 1, or directly into the irrigation line 15, if the storage containers 104a-104e are coupled directly to the irrigation line 15 without a mixing chamber 52 therebetween).

In some embodiments, the fertigation supply unit 100 dispenses the fertilizer components, herbicides and/or insecticides into the irrigation line 15 until the total amounts of the fertilizer components, herbicides and/or insecticides determined (as described above) by the processor 16 of the fertigation control unit 14 to be optimal for dispensing in a given geographical location during this summer fertigation cycle have been dispensed by the sprinklers 25a-25c of each irrigation zone 22a-22c. As mentioned above, the fertigation control unit 14 can include a visual indicator in the form of an LED light or an on-screen message that indicates whether the fertigation mode is on or off, e.g., green light indicating that the fertigation mode is on and a red light indicating that the fertigation mode is off.

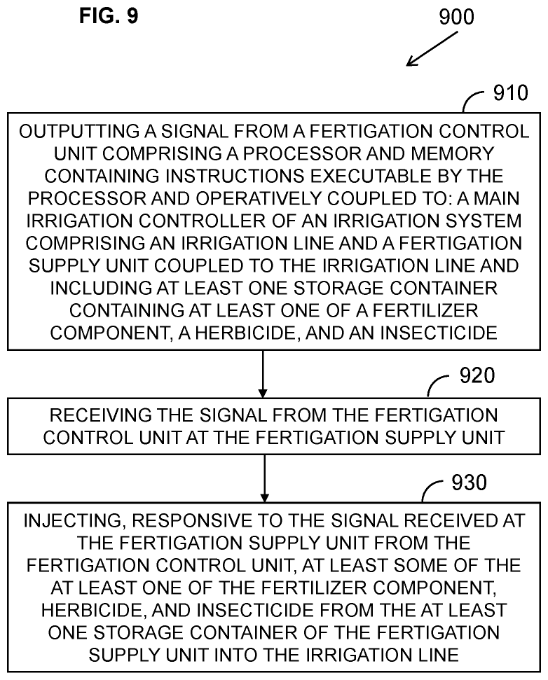

With reference to FIG. 9, an exemplary method 900 for controlling a fertigation system will now be described. For exemplary purposes, the method is described in the context of the system of FIG. 1, but it is understood that embodiments of the method may be implemented in this or other systems. The method includes outputting a signal (e.g., via the connection 54) from the fertigation control unit (e.g., fertigation control unit 14 of the fertigation system 10) (step 910). As discussed above, in some embodiments, the fertigation system 10 includes an irrigation line 15 and a fertigation supply unit 100 coupled to the irrigation line 15 (for example, via the mixing chamber 52 and the shut-off valve 51 and the selection manifold 46 via the connection 50. The fertigation supply unit 100 includes storage containers 104a-104e that contain the fertilizer components, herbicides, and/or insecticides to be released into the irrigation line 15. The fertigation control unit comprises a processor 16 and a memory 20 (e.g., that stores at least time of year data, historical air/soil temperature data, zone areas, types of vegetation in the zones, as well as instructions executable by the processor 16).

In the exemplary method 900 depicted in FIG. 9, the outputting of the signal by the fertigation control unit 14 can be in response to receiving, at the fertigation control unit 14, at least one of air and soil temperature data from at least one sensor, for example, the air temperature sensor 32 and/or the soil temperature sensor 36. In one approach, the outputting of the signal by the fertigation control unit 14 in step 910 can be in response to a determination, at the fertigation control unit 14, that the air and/or soil temperatures received from the air temperature sensor 32 and/or the soil temperature sensor 36 are exhibiting a trend that is approaching a predetermined temperature threshold for beginning of a seasonal fertigation cycle (e.g., temperatures of 50-55° F. for triggering the spring fertigation cycle, temperatures of 80-85° F. for triggering the summer fertigation cycle, temperatures of 65-70° F. for triggering the fall fertigation cycle, and temperatures of 45-50° F. for triggering the late fall/winter fertigation cycle.

The predetermined temperature thresholds can be, for example, a minimum optimal fertigation temperature for the system to be in the fertigation operation for a given time of year/season. As described above, the threshold temperatures that are interpreted by the processor of the fertigation control unit 14 to be associated with triggering fertigation for a given season can be stored in the memory of the fertigation control unit 14.

In another approach, the outputting of the signal by the fertigation control unit 14 in step 910 can be in response to receiving a manual user input, for example, a command to initialize the (spring, summer, fall, or winter) fertigation cycle. As described above, the user input to initialize the fertigation cycle can be provided at the location of the fertigation control unit 14 (e.g., by manual manipulation of the user interface 228 of FIG. 3) or via a wired or wireless connection from a remote location such a central station or a central controller. In one approach, the manual user input resulting the outputting of the signal by the fertigation control unit in step 910 can be a calendar date (triggering the start-up of the seasonal fertigation) previously entered or selected through manual user input by the user into the fertigation control unit 14, where the reaching of the stored calendar date triggers the outputting of the signal.

In step 920 of the method 900 in FIG. 9, the signal that is output by the fertigation control unit 14 in step 910 is received at the fertigation supply unit (e.g., fertigation supply unit 100 or 700). As discussed above, the signal sent by the fertigation control unit 14 to the fertigation supply unit 100 can be an electrical signal (e.g., an A/C power signal) and/or a data signal that is sent via a wired connection or wirelessly. In one approach, as shown in FIG. 7, the fertigation supply unit 700 can include logic circuitry adapted to interpret the signal received from the fertigation control unit 14. For example, such logic circuitry can be implemented into or coupled to a pump (e.g., pump 748) that forms a part of the fertigation supply unit and which is coupled to the fertigation storage container (e.g., containers 104a-104e).

Next, at step 930, the method 900 of FIG. 9 includes injecting, responsive to the signal received at the fertigation supply unit from the fertigation control unit 14, at least some of the fertilizer components, herbicides, and/or insecticides from the storage containers 104a, 104b, 104c, 104d, and/or 104e of the fertigation supply unit 100 into the irrigation line 15. As discussed above, the injecting step 930 may include activating the pump (e.g., pump 748 of the fertigation supply unit 700 of FIG. 7, or the pump 48 coupled to the fertigation supply unit 100 of FIG. 1) to initiate the injection of at least some of the fertilizer components, herbicides, and/or insecticides from the storage containers 104a, 104b, 104c, 104d, and/or 104e of the fertigation supply unit 100 into the irrigation line 15).

In some embodiments, at step 930, the fertigation supply unit 100 dispenses the fertilizer components, herbicides and/or insecticides into the irrigation line 15 for a prescribed duration of time until the amounts of the fertilizer components, herbicides and/or insecticides determined (as described above) by the processor 16 of the fertigation control unit 14 to be optimal for dispensing in the prescribed geographic area during the prescribed calendar dates during this fertigation cycle have been dispensed by the sprinklers 25a-25c of each irrigation zone 22a-22c. As mentioned above, system 10 may lack the pumps 48 and 748, and the storage containers 104a-104e may be pressurized containers that can inject the fertilizer components, herbicides, and/or insecticides into the irrigation line 15 when a valve (e.g., valve of the selection manifold 46 or another valve) coupled to the pressurized containers is opened in response to the signal (e.g., a power signal and/or a data signal) received at the fertigation supply unit 100 from the fertigation control unit 14.

Some embodiments of the exemplary automatic fertigation systems described above have advantages over currently known systems at least because they eliminate the need for homeowners to manually figure out when to fertilize their lawns/plants, and how much fertilizer/herbicide/insecticide to apply to achieve an optimal effect on the growth and health of the greenscape. Similarly, the fertigation systems described above save the homeowners operation costs and aggravation of being dependent on the availability of a service person to seasonally fertilize their greenscape. When using the presently described fertigation systems, the homeowner or the light commercial property owner is assured that the lawn/plants being irrigated by his/her irrigation system are being fertigated at the optimal seasonal fertigation time and by optimal quantities of fertilizer components, herbicides, and insecticide each and every year without having to be concerned when to fertilize, or what concentrations/quantities of fertilizer components, herbicides, and/or insecticides to use at which seasonal fertigation cycle.

While the invention herein disclosed has been described by means of specific embodiments, examples and applications thereof, numerous modifications and variations could be made thereto by those skilled in the art without departing from the scope of the invention set forth in the claims.

What is claimed is:

1. A fertigation system comprising:
a fertigation supply unit coupled to an irrigation line of an irrigation system, the fertigation supply unit including at least one storage container containing at least one of a fertilizer component, a herbicide, and an insecticide; and
a fertigation control unit operatively coupled to a main irrigation controller of the irrigation system and in communication with the fertigation supply unit, the fertigation control unit being configured to send a signal to the fertigation supply unit and the fertigation supply unit being configured to inject at least some of the at least one of the fertilizer component, herbicide, and insecticide from the at least one storage container into the irrigation in response to receiving the signal from the fertigation control unit;
at least one of an air temperature sensor, a soil temperature sensor, and a flow sensor coupled to the irrigation and the fertigation control unit, the air temperature sensor being configured to send to the fertigation control unit temperature data for ambient air, the flow sensor being configured to send to the fertigation control unit flow rate data for at least one of water, the fertilizer component, the herbicide, and the insecticide in the irrigation, and the soil temperature sensor being configured to send to the fertigation control unit temperature data for soil proximate the irrigation;
wherein the fertigation control unit is configured to determine, based on at least one of time of year data stored in the fertigation control unit, air temperature values stored in the fertigation control unit, soil temperature values stored in the fertigation control unit, air temperature data received by the fertigation control unit from the air temperature sensor, and soil temperature data received by the fertigation control unit from the soil temperature sensor:
a time for initiating injection, from the fertigation supply unit, of at least some of the at least one of the fertilizer component, herbicide, and insecticide into the irrigation; and
relative amounts of the at least one of the fertilizer component, herbicide, and insecticide to be released upon the injection from the at least one storage container into the irrigation.

2. The fertigation system of claim 1, further comprising:
at least one inlet port that permits the at least one storage container to release at least some of the at least one of the fertilizer component, herbicide, and insecticide therefrom;
a pump configured to inject the at least one of the fertilizer component, herbicide, and insecticide released from the at least one storage container into a mixing chamber.

3. The fertigation system of claim 2, further comprising an injection port positioned between the mixing chamber and the irrigation, the injection port being configured to permit a mixture released from the mixing chamber to be injected into the irrigation, the injection port including one of a check valve and a two-way valve.

4. The fertigation system of claim 1, wherein the fertigation control unit includes a visible status indicator indicating whether at least some of the at least one of the fertilizer component, herbicide, and insecticide from the at least one storage container has been injected into the irrigation.

5. The fertigation system of claim 1, further comprising a master valve coupled to the irrigation, the fertigation control unit, and the fertigation supply unit, the master valve being configured to any one of permit and restrict flow of at least one of water, fertilizer component, herbicide, and insecticide through the irrigation.

6. The fertigation system of claim 1, wherein the fertigation supply unit includes a first storage container that stores nitrogen and its derivatives, a second storage container that stores phosphorus, and a third storage container that stores potassium and its derivatives, a fourth storage container that stores the herbicide, and a fifth storage container that stores the insecticide.

7. The fertigation system of claim 6, wherein each one of the first, second, third, fourth, and fifth storage containers is configured as a pressurized container with a lid that is configured to be connected directly to the irrigation at a user-selected location.

8. The fertigation system of claim 1, wherein the fertigation control unit is one of:
an accessory control unit physically coupled via a detachable connection to the main irrigation controller;
an internal component of the main irrigation controller;
a mobile electronic device of a user configured for communication with the main irrigation controller; and
a server located in a location that is remote to the main irrigation controller, the server being configured for communication with the main irrigation controller.

9. The fertigation system of claim 1, wherein the fertigation supply unit includes a pump positioned within a housing of the fertigation supply unit, the pump including logic circuitry configured to receive the control signal from the fertigation control unit and to inject the at least one of the fertilizer component, herbicide, and insecticide from the at least one storage container of the fertigation supply unit into the irrigation.

10. The fertigation system of claim 1, wherein the fertigation control unit is configured to permit a user to pre-select irrigation zones where zone valves are to be activated by the fertigation control unit for fertigation, and to pre-select irrigation zones where the zone valves are not to be activated by the fertigation control unit for fertigation.

11. A fertigation control unit operatively coupled to a main irrigation controller of an irrigation system, the fertigation control unit comprising:
a memory storing time of year data, air temperature data, and soil temperature data associated with a geographical location where the irrigation system is located;
an output configured to be in communication with a fertigation supply unit coupled to an irrigation of the irrigation system, the fertigation supply unit including at least one storage container containing at least one of a fertilizer component, a herbicide, and an insecticide; and
a processor coupled to the memory and the output;
wherein, upon a determination by the processor that the time of year data, air temperature data, and soil temperature data support activation of the fertigation control unit, the processor is configured, to generate at the output a signal to the fertigation supply unit, the signal being configured to cause the fertigation supply unit to inject at least some of the at least one of the fertilizer component, herbicide, and insecticide from the at least one storage container of the fertigation supply unit into the irrigation.

12. The fertigation control unit of claim 11, wherein the processor of the fertigation control unit is configured to generate the signal in response to a manual user input.

13. The fertigation control unit of claim 11, wherein the fertigation control unit is configured to receive at least one of the air temperature data and soil temperature data from at least one sensor coupled to at least one of the fertigation control unit and the irrigation.

14. The fertigation control unit of claim 13, wherein the memory of the fertigation control unit stores historical values of the at least one of the air and soil and area of greenscape associated with the geographical location of the irrigation system, the processor being configured to analyze, in view of the stored historical values, the at least one of the air temperature data and soil temperature data received from the at least one sensor, and to determine:
a time for initiating injection, from the fertigation supply unit, of at least some of the at least one of the fertilizer component, herbicide, and insecticide into the irrigation; and
relative amounts of the at least one of the fertilizer component, herbicide, and insecticide to be released upon the injection from the at least one storage container into the irrigation.

15. The fertigation control unit of claim 11, wherein the memory includes at least one air temperature threshold and at least one soil temperature threshold, area of greenscape where the irrigation system is installed, and the processor is configured to generate the signal at the output upon a determination by the processor that at least one of the threshold associated with the air temperature and the threshold associated with the soil temperature has been reached.

16. The fertigation control unit of claim 11, wherein the fertigation control unit is one of:
an accessory control unit physically coupled via a detachable connection to the main irrigation controller;
an internal component of the main irrigation controller;
a mobile electronic device of a user configured for communication with the main irrigation controller; and
a server located in a location that is remote to the main irrigation controller, the server being configured for communication with the main irrigation controller.

17. The fertigation control unit of claim 11, wherein the processor of the fertigation control unit is configured to generate at least one signal at the output to control at least one of:
duration of injection by the fertigation supply unit of the at least one of the fertilizer component, herbicide, and insecticide from the at least one storage container into the irrigation; and
relative amounts of the at least one of the fertilizer component, herbicide, and insecticide to be released upon the injection from the at least one storage container into the irrigation.

18. The fertigation control unit of claim 11, wherein the fertigation control unit includes a visible status indicator indicating whether at least some of the at least one of the fertilizer component, herbicide, and insecticide from the at least one storage container has been injected into the irrigation.

19. The fertigation control unit of claim 11, wherein the fertigation control unit is configured to permit a user to pre-select irrigation zones where zone valves are to be activated by the fertigation control unit for fertigation, and to pre-select irrigation zones where the zone valves are not to be activated by the fertigation control unit for fertigation.

20. A method for controlling a fertigation system, the method comprising:
outputting a signal from a fertigation control unit operatively coupled to:
a main irrigation controller of an irrigation system comprising an irrigation and
a fertigation supply unit coupled to the irrigation and including at least one storage container containing at least one of a fertilizer component, a herbicide, and an insecticide,
wherein the fertigation control unit comprises a processor and memory containing instructions executable by the processor;
receiving, at the fertigation control unit, at least one of air temperature data and soil temperature data from at least one sensor coupled to at least one of the fertigation control unit and the irrigation;
programming the fertigation control unit with historical values of the at least one of the air and soil associated with the geographical location of the irrigation system;
analyzing, via the processor of the fertigation control unit and in view of the stored historical values, the at least one of the air temperature data and soil temperature data received from the at least one sensor;
determining by the processor of the fertigation control unit and based on the analyzing:
a time for initiating injection, from the fertigation supply unit, of at least some of the at least one of the fertilizer component, herbicide, and insecticide into the irrigation; and
duration of the injection and relative amounts of the at least one of the fertilizer component, herbicide, and insecticide to be released upon the injection from the at least one storage container into the irrigation;
receiving the signal from the fertigation control unit at the fertigation supply unit; and
injecting, responsive to the signal received at the fertigation supply unit from the fertigation control unit, at least some of the at least one of the fertilizer component, herbicide, and insecticide from the at least one storage container of the fertigation supply unit into the irrigation.

21. The method of claim 20, further comprising:
storing in the memory of the fertigation control at least one air temperature threshold and at least one soil temperature threshold; and
generating, via the processor of the fertigation control unit, the signal at the output upon a determination by the processor of the fertigation control unit that at least one of the threshold associated with the air temperature and the threshold associated with the soil temperature has been reached.

22. The method of claim 20, further comprising, via a user interface of the fertigation control unit, permitting a user to pre-select irrigation zones where zone valves are to be activated by the fertigation control unit for fertigation, and to pre-select irrigation zones where the zone valves are not to be activated by the fertigation control unit for fertigation
